(19) United States
(12) Patent Application Publication
(10) Pub. No.: US 2021/0314553 A1
(43) Pub. Date: Oct. 7, 2021

(54) THREE-DIMENSIONAL DISPLAY METHOD BASED ON SPATIAL SUPERPOSITION OF SUB-PIXELS' EMITTED BEAMS

(71) Applicant: SUN YAT-SEN UNIVERSITY, Guangdong (CN)

(72) Inventors: Dongdong TENG, Guangdong (CN); Lilin LIU, Guangdong (CN)

(73) Assignee: SUN YAT-SEN UNIVERSITY, Guangdong (CN)

(21) Appl. No.: 17/226,093

(22) Filed: Apr. 9, 2021

Related U.S. Application Data
(63) Continuation of application No. PCT/CN2020/091873, filed on May 22, 2020.

(30) Foreign Application Priority Data
Apr. 3, 2020 (CN) 202010259368.5

(51) Int. Cl. H04N 13/32; G02B 30/24; G02B 30/25; H04N 13/324; H04N 13/398; H04N 13/385; H04N 13/383

(52) U.S. Cl. CPC H04N 13/32; G02B 30/24; G02B 30/25; H04N 13/383; H04N 13/398; H04N 13/385; H04N 13/324

(57) ABSTRACT

The invention discloses a three-dimensional display method based on spatial superposition of sub-pixels' emitted beams. Taking sub-pixels of a display device as the basic display units, sub-pixels that emitting beams of the same color are taken as a sub-pixel group or divided into several sub-pixel groups. Through a beam control device, the sub-pixel groups project more than one image of the target object to a same pupil of the viewer. Passing through a displayed spatial point, more than one beam from sub-pixels of different colors superimpose into a color spatial light spot, where the mosaic of sub-pixels of different colors is employed to present surface-distributed color pixel. The beam control device guides the beam from each sub-pixel to the viewing zone corresponding to a sub-pixel group that contains the sub-pixel, along a special direction and with a constrained divergence angle.

### CROSS-REFERENCE TO RELATED APPLICATIONS

This application is a continuation of international PCT application serial no. PCT/CN2020/091873, filed on May 22, 2020, which claims the priority benefit of China application no. 202010259368.5, filed on Apr. 3, 2020. The entirety of each of the above-mentioned patent applications is hereby incorporated by reference herein and made a part of this specification.

### TECHNICAL FIELD

The present invention relates to the technical field of three-dimensional display, and more particularly to a display based on spatial superposition of sub-pixels' emitted beams.

### BACKGROUND

Compared with the traditional two-dimensional display, the three-dimensional display can present optical object whose dimensions are consistent with the real world, and is receiving more and more attention. Stereoscopic technology (including automatic stereoscopic) for three-dimensional display gets implemented by binocular parallax, through projecting a corresponding two-dimensional image of the displayed object to each eye of the viewer. The crossover between view directions of the viewer's two eyes stimulates the depth perception. In order to see their corresponding two-dimensional images clearly, two eyes of the viewer need to keep focusing on the display device, resulting in a vergence-accommodation conflict problem. That is to say, the viewer's monocular focusing depth and the binocular convergence depth are inconsistent. This inconsistency between the monocular focusing depth and the binocular convergence depth violates the physiological habit when people observe a real three-dimensional object. This inconsistency brings visual discomfort to the viewer, and has become the bottleneck problem hindering the popularization and application of 3D display. One-eye-multiple-view is an effective technical path to solve the vergence-accommodation problem, which projects at least two different images of the displayed object to different segments of a same pupil through a beam control device. Thus, passing through a displayed point, at least two beams from the at least two images perceived by the pupil superpose into a spatial light spot that the eye can focus on naturally.

### SUMMARY

The present invention proposes a three-dimensional display method based on spatial superposition of the sub-pixels' emitted beams. The sub-pixels of a display device are used as basic display units. Sub-pixels those emit beams of the same color are taken as a sub-pixel group, or divided into several sub-pixel groups. The sub-pixel groups project more than one image of the displayed object to a same pupil of the viewer, for focusable three-dimensional object display based on one-eye-multiple-view. Existing one-eye-multiple-view technologies present a focusable spatial light spot by superposition of color beams from different pixels. That is to say, at least two pixels are necessary for the presentation of a spatial light spot, such as what have been done in U.S. Pat. No. 10,652,526 B2 (THREE-DIMENTIONAL DISPLAY SYSTEM BASED ON DIVISION MULTIPLEXING OF VIEWER'S ENTRANCE-PUPIL AND DISPLAY METHOD) and PCT/IB2017/055664 (NEAR-EYE SEQUENTIAL LIGHT-FIELD PROJECTOR WITH CORRECT MONOCULAR DEPTH CUES). In this patent, presenting a focusable spatial light spots gets implemented by superimposition of monochromatic beams from different sub-pixels. Compared with the at least two pixels required by the existing one-eye-multiple-view technologies, the method described in this patent only requires at least two sub-pixels for presenting a focusable spatial light spot. So, with sub-pixels as the basic display units, the one-eye-multiple-view technology of this patent can effectively increase the number of projected perspective views, which is benefit for the expansion of the viewing area, or the enlargement of the display depth through providing denser viewing zones. Furthermore, through introducing in a projection device to project an enlarged image of the display device, the application range of the method is extended to near-eye display field. A relay device is also designed for optimizing the optical structure. The method not only can be directly applied to a binocular optical engine, but also is suitable for a monocular optical engine.

With sub-pixels as the display units, to realize three-dimensional display based on one-eye-multiple-view, the present invention proposes the following solutions:

A three-dimensional display method based on spatial superposition of sub-pixels' emitted beams, wherein the method comprises the following steps:

(i) Taking sub-pixels of a display device as basic display units, all sub-pixels emitting beams of a same color are taken as a sub-pixel group or divided into several sub-pixel groups;

wherein, all sub-pixels of the display device belong to K′ kinds of elementary colors respectively, including sub-pixels of K kinds of primary colors, where K′≥K≥2;

wherein, there exist K kinds of filters corresponding to sub-pixels of the K kinds of primary-colors by a one-to-one manner, which have characteristics that a ratio between transmittance of the beams emitted by each kind of primary-color sub-pixels with respect to the corresponding filter and that of the beams emitted by each kind of primary-color sub-pixels with respect to any other (K−1) kinds of non-corresponding filters is large than 9;

and, the color of the beams emitted by a kind of elementary-color sub-pixels is defined as an elementary color, and a total of K′ kinds of elementary colors exist; the color of the beams emitted by a kind of primary-color sub-pixels is defined as a primary color and a total of K kinds of primary colors exist;

(ii) using a beam control device to guide the beam from each sub-pixel to the viewing zone corresponding to the sub-pixel group which contains the sub-pixel respectively, and to constrain the divergence angle of the beam from each sub-pixel;

wherein the constrained divergence angle of each beam is designed for a required light distribution on the plane containing the pupil of the viewer, and the required light distribution satisfies that a light distribution area with a light intensity value greater than 50% of a peak light intensity is smaller than a diameter of the pupil along at least one direction;

(iii) controlling each sub-pixel group to load and display a corresponding image by a control apparatus which is connected with the display device, wherein the image message loaded on each sub-pixel is a target object's projection message along the sub-pixel's emitted beam;

wherein, the image displayed by a sub-pixel group is a perspective view of the target object, and the image displayed by a composite sub-pixel group which is tiled by mutually complementary parts of different sub-pixel groups is a composite perspective view;

wherein, the spatial position distribution of the viewing zones corresponding to different sub-pixel groups are arranged to guarantee the same pupil of the viewer perceiving at least two perspective views, or at least two composite perspective views, or at least one perspective view and one composite perspective view.

Furthermore, the beam control device is an aperture array consisting of at least one aperture group;

wherein, each aperture group contains K apertures, with each aperture attached by one said filter and different apertures attached by different kinds of the filters;

wherein, for each aperture, a sub-pixel group consisting of sub-pixels corresponding to the aperture's filter takes the aperture as the viewing zone when the beams from the sub-pixel-group pass through the aperture.

Furthermore, the aperture array contains M aperture groups, and different aperture groups only allow light with different orthogonal characteristics passing through, respectively, where M≥2.

Furthermore, the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and two polarization states of left-handed circular polarization and right-handed circular polarization.

Furthermore, the beam control device is an aperture array consisting of at least one aperture group,

wherein, each aperture group contains K′ apertures, with the K′ apertures of the aperture group corresponding to K′ kinds of elementary colors in a one-to-one manner;

wherein, the aperture corresponding to a primary color is attached by the filter corresponding to the primary color;

and for each aperture, a sub-pixel group emitting light with an elementary color corresponding to this aperture takes the aperture as the corresponding viewing zone when the beams from the sub-pixel group passing through the aperture;

wherein, the K apertures of an aperture group attached by filters allow beams with an identical orthogonal characteristic passing through, while the other (K′−K) apertures of this aperture group respectively allow light of the other (K′−K) kinds of corresponding orthogonal characteristics passing through, with all these (K′−K+1) kinds of orthogonal characteristics being mutually different.

Furthermore, the aperture array contains M aperture groups, and different aperture groups only allow light with mutually different orthogonal characteristics passing through, respectively, where M≥2.

Furthermore, the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and the two polarization states of left-handed circular polarization and right-handed circular polarization.

Furthermore, the display device is a passive display device equipped with a backlight array consisting of at least one backlight group, and the beam control device is an optical device which projects a real image of the backlight array;

wherein, each backlight group consists of K backlights which emit light of K different kinds of primary colors, respectively,

and the light distribution area of the real image of the backlight array is taken as the viewing zone of the sub-pixel group which emit light of the color same to the backlight and whose emitted beams pass through the light distribution area.

Furthermore, the backlight array contains M backlight groups, and different backlight groups emit light with mutually different orthogonal characteristics, where M≥2.

Furthermore, the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and the two polarization states of left-handed circular polarization and right-handed circular polarization.

Furthermore, the display device is a passive display device equipped with a backlight array consisting of at least one backlight group, and the beam control device is an optical device which projects a real image of the backlight array;

wherein, each backlight group consists of K′ backlights which emit light of K′ kinds of elementary colors, respectively,

and the light distribution area of the real image of the backlight array is taken as the viewing zone of a sub-pixel group which emits light of a color same to this backlight and whose emitted beams pass through this light distribution area;

wherein, the K backlights of a backlight group which emit light of K kinds of primary colors have an identical orthogonal characteristics, while other (K′−K) backlights of the backlight group emit light of other (K′−K) kinds of orthogonal characteristics, respectively, with all the (K′−K+1) kinds of orthogonal characteristics being mutually different.

Furthermore, the backlight array contains M backlight groups, and different backlight groups emit light of mutually different orthogonal characteristics, respectively, where M≥2.

Furthermore, the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and the two polarization states of left-handed circular polarization and right-handed circular polarization.

Furthermore, the step (ii) further comprises placing a projection device at a position corresponding to the display device to form an enlarged image of the display device.

Furthermore, the step (ii) further comprises inserting a relay device into the optical path to guide the beams from the display device to the area around the pupil or pupils of the viewer.

Furthermore, the relay device is a reflective surface, or a semi-transparent semi-reflective surface, or a free-surface relay device, or an optical waveguide device.

Furthermore, the step (iii) further comprises real-timely determining a position of the viewer's pupil by a tracking device connecting with the control apparatus.

Furthermore, the step (iii) further comprises determining the sub-pixels whose emitted beams enter the pupil according to the real-time position of the pupil, and setting message loaded on each of the sub-pixels to be the target object's projection message along one beam of its emitted light which enters into the pupil.

Furthermore, the step (iii) further comprises determining the sub-pixel groups whose emitted beams enter the pupil according to the real-time position of the pupil, and taking the sub-pixel groups as effective sub-pixel groups.

Compared with existing one-eye-multiple-view technologies which employ pixels as display units, the usage of sub-pixels as basic display units can increase the number of projected two-dimensional perspective views. Through introducing temporal multiplexing or/and spatial multiplexing, more two-dimensional perspective views are expected to further improve the quality of the one-eye-multiple-view display.

The present invention provides a method for three-dimensional display free of vergence-accommodation conflict. With sub-pixels as the basic display units, the technology of the present patent application can increase the number of projected perspective views effectively, which is beneficial for expansion of viewing zone or enlargement of the display depth. Furthermore, through introducing in a projection device to project an enlarged image of the display device, the applicable range of the proposed method is extended to near-eye display field. A relay device is also designed for optimizing the optical structure. The method not only can be directly applied to a binocular optical engine, but also is suitable for a monocular optical engine.

The details of the embodiments of the present invention are embodied in the drawings or the following descriptions. Other features, objects, and advantages of the present invention will become more apparent from the following descriptions and drawings.

### BRIEF DESCRIPTION OF THE DRAWINGS

The drawings are used to help better understand the present invention and are also part of the description. The drawings and descriptions illustrating the embodiments together serve to explain the principles of the present invention.

FIG. 1 is a schematic view of existing one-eye-multi-view display with pixels as basic display units.

FIG. 2 is a schematic view showing a three-dimensional display method based on superposition of sub-pixels' emitted beams in present application.

FIG. 3 shows the construction of a composite sub-pixel group.

FIG. 4 is a schematic view showing a depth region where no superposition of beams occurs.

FIG. 5 shows the structure of a projection device.

FIG. 6 is an example of light propagation path deflected by the relay device.

FIG. 7 is a schematic view showing the aperture-type beam control device's working principle.

FIG. 8 is a schematic view showing the working principle of an aperture-type beam control device based on linear polarization characteristics.

FIG. 9 is a schematic view showing the working principle of an aperture-type beam control device based on temporal orthogonal characteristics.

FIG. 10 is a schematic view showing the working principle of an aperture-type beam control device based on hybrid orthogonal characteristics.

FIG. 11 is a schematic view showing the working principle of an aperture-type beam control device based on another kind of hybrid orthogonal characteristics.

FIG. 12 is a schematic view of a binocular display structure based on an aperture-type beam control device.

FIG. 13 is a schematic view of a near-eye monocular optical engine based on an aperture-type beam control device.

FIG. 14 is a schematic view of a near-eye binocular optical engine based on an aperture-type beam control device.

FIG. 15 shows the 1^{st} example of the near-eye monocular compound-structure optical engine based on an aperture-type beam control device.

FIG. 16 shows the 2^{nd} example of the near-eye monocular compound-structure optical engine based on an aperture-type beam control device.

FIG. 17 shows the 3rd example of the near-eye monocular compound-structure optical engine based on an aperture-type beam control device.

FIG. 18 shows the 4^{th} example of the near-eye monocular compound-structure optical engine based on an aperture-type beam control device.

FIG. 19 is a structural assembly view of a thin and light monocular optical engine based on an aperture-type beam control device.

FIG. 20 shows the 5^{th} example of the near-eye monocular compound-structure optical engine based on an aperture-type beam control device.

FIG. 21 is a schematic view of a free-surface relay device.

FIG. 22 is a schematic view of a waveguide-type relay device.

FIG. 23 is a schematic view showing a stack structure of multiple optical waveguides.

FIG. 24 is a schematic view of the other waveguide-type relay device.

FIG. 25 is a schematic view of another waveguide-type relay device.

FIG. 26 is a schematic view of the imaging-type beam control device.

FIG. 27 shows the working principle of an imaging-type beam control device accompanied by linear-polarization characteristics.

FIG. 28 shows the working principle of an imaging-type beam control device based on temporal orthogonal characteristics.

FIG. 29 shows the working principle of an imaging-type beam control device based on hybrid orthogonal characteristics.

FIG. 30 is a schematic view of a binocular display structure based on an imaging-type beam control device.

FIG. 31 is a schematic view of the backlights' shapes.

FIG. 32 is a schematic view of the slanting arrangement of the striped viewing zone relative to the direction of a line connecting the viewer's two eyes.

FIG. 33 is a schematic view of a composite structure.

FIG. 34 shows the 1^{st} example of the near-eye monocular optical engine based on imaging-type beam control device.

FIG. 35 shows the 2^{nd} example of the near-eye monocular optical engine based on imaging-type beam control device.

FIG. 36 shows an example of the near-eye binocular optical engine based on imaging-type beam control device.

FIG. 37 shows the 3^{rd} example of the near-eye monocular optical engine based on imaging-type beam control device.

FIG. 38 shows the 4^{th} example of the near-eye monocular optical engine based on imaging-type beam control device.

FIG. 39 shows the 5^{th} example of the near-eye monocular optical engine based on imaging-type beam control device.

FIG. 40 shows the 6^{th} example of the near-eye monocular optical engine based on imaging-type beam control device.

FIG. 41 is a schematic view of a free-surface relay device.

FIG. 42 shows the 1^{st} example of a waveguide-type relay device.

FIG. 43 shows the 2^{nd} example of a waveguide-type relay device.

### DETAILED DESCRIPTION

The present invention discloses a three-dimensional display method based on superposition of sub-pixels' emitted beams, which takes sub-pixels as the basic display units. Multiple sub-pixel groups of the display device 10 project at least two two-dimensional images of the target object to different segments of a same pupil. The beams from different images perceived by one eye superpose into a displayed spatial object that the eye can focus on naturally, with the vergence-accommodation conflict being overcome.

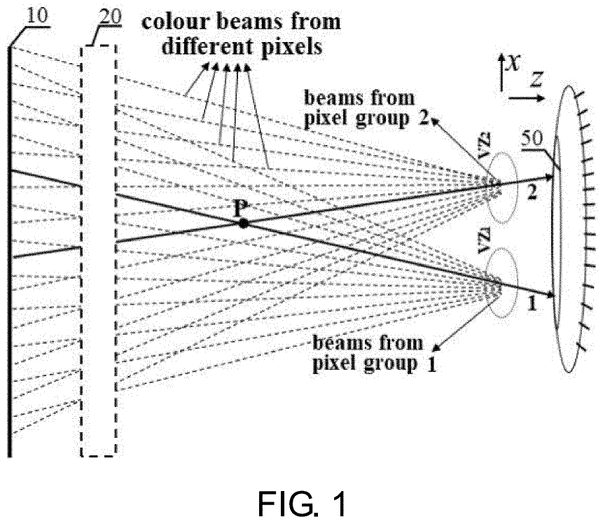

Existing one-eye-multiple-view technologies all take pixels as the basic display units. Through projecting at least two two-dimensional images to a same pupil 50 of the viewer, the target object gets displayed by superposition of at least two passing-through beams from the at least two images at each object point. When the light intensity distribution of a superposition spot possesses enough attraction to the viewer's eyes, the viewer's eyes can focus on the superposition spot naturally, thus overcoming the vergence-accommodation conflict. In this process, on a plane containing the pupil 50 of the viewer, the light distribution area of the beam from a pixel with the light intensity value being greater than 50% of the peak light intensity should be smaller than the diameter Dₚ of the pupil 50 along at least one direction. The plane containing the pupil 50 is called pupil plane here. The at least two images come from at least two pixel groups of the display device 10 correspondingly through guidance of the beam control device 20. The image projected by a pixel group is a perspective view with a corresponding viewing zone. Particularly, FIG. 1 gives a monocular structure with two images for one eye as an example.

Guided by the beam control device 20, the pixel group 1 projects perspective view 1 to the pupil 50 through the corresponding viewing zone VZ₁, and the pixel group 2 projects perspective view 2 to the pupil 50 through the corresponding viewing zone VZ₂. The viewing zones are arranged along x direction. At a displayed point P, the light beam 1 from the pixel group 1 and the light beam 2 from the pixel group 2 get superposed into a superimposition spatial light spot. When the light intensity distribution of the superimposition spatial light spot can attract the eye's focus, the eye will no longer be forced to focus at the exit pixel of beam 1 or beam 2. That is to say, the viewer's eye will not be kept focusing at the display device 10. So, the accommodation-convergence conflict gets overcome. Many such spatial light spots as the superimposition spatial light spot at the point P construct the displayed spatial object. FIG. 1 is drawn to explain the basic principle of one-eye-multiple-view technologies with a monocular structure, and no concrete structure gets involved. The beam control device 20 is replaced by a virtual frame, without considering its practical structure. Moreover, the position relation between the beam control device 20 and the display device 10 is also schematically drawn in the FIG. 1. It does not mean that the actual position relation between the beam control device 20 and the display device 10 has to be identical to that of the FIG. 1.

Actually, increasing the number and distribution density of the viewing zones will make more images perceived by a same pupil 50. Thus, for a displayed spatial light spot, more passing-through beams will be perceived by the corresponding pupil. The superposition of more beams can give the superimposition spatial light spot more attraction to the eye's focus, resulting in a larger display depth. At the same time, more viewing zones can provide a larger observing space for the pupil 50. The increasing of the number of the viewing zones means a larger number of perspective views to be presented. A perspective view is presented by a pixel group. So, it also means that the beam control device 20 needs to divide the pixels of the display device 10 into more pixel groups for more perspective views. The pixel groups are often obtained through dividing the pixels of the display device 10 by spatial multiplexing or temporal multiplexing. The spatial multiplexing spatially divides the pixels of the display device 10 into different pixel groups which correspond to different viewing zones. The pixels of each pixel group are different from those of other pixel groups. Under this condition, more pixel groups mean a smaller number of pixels in each pixel group, also mean a smaller resolution of the projected perspective view. Temporal multiplexing divides the pixels of the display device 10 into different pixel groups projecting perspectives at different time-points of a time period. Also, different pixel groups can share the same pixel, more pixel groups mean a lower display frequency.

FIG. 1 describes the working principle of a conventional one-eye-multiple-view display by a monocular display structure, in which each beam is emitted by the corresponding pixel. Each pixel contains more than one sub-pixel. Sub-pixels of a pixel emit light of different colors, respectively. The beams from different sub-pixels of a pixel mix into a color emitted beam of this pixel. During the display process, through the beam control device 20, the color beams with constrained divergence angles and specific propagating directions from different pixels will superpose into the spatial spot that the eye 50 can focus on. Two perspective views which are required for the process shown in FIG. 1 are projected by two pixel groups into which the pixels of the display device 10 are divided.

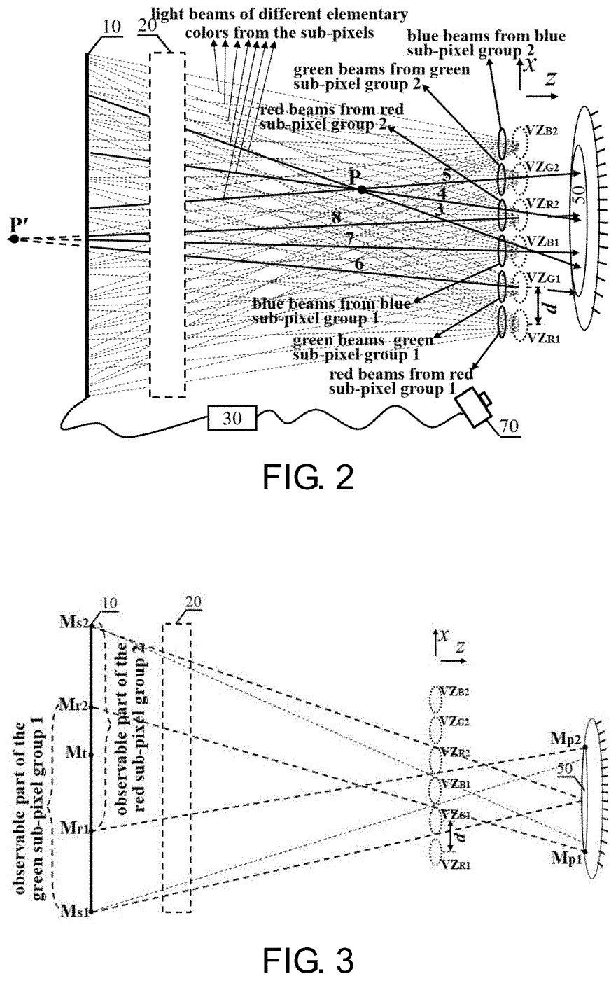

Different to the one-eye-multiple-view display using pixels as the basic units shown in FIG. 1, the present patent application uses sub-pixels as the basic display units to perform one-eye-multiple-view display. Sub-pixels that emit beams of the same color are individually taken as a sub-pixel group or divided into multiple sub-pixel groups. In the present patent application, the sub-pixel and sub-pixel group both are named by the color of the beam or beams from them, such as green sub-pixel or green sub-pixel group. FIG. 2 takes a display device 10 as example, each pixel of which consists of three sub-pixels (R (red), G (green), and B (blue)). The three kinds of sub-pixels, R, G and B, emit red light, green light and blue light, respectively.

In the present patent application, all sub-pixels of the display device 10 belong to K′ kinds of elementary-color sub-pixels which emit beams of K′ kinds of colors, respectively. Among the K′ kinds of elementary-color sub-pixels, there exist K kinds of primary-color sub-pixels. Here K′≥K≥2. The K kinds of primary-color sub-pixels satisfy the following conditions: there are K kinds of filters which correspond to the K kinds of primary-color sub-pixels by a one-to-one manner, and a ratio between transmittance of the beams emitted by each kind of primary-color sub-pixels with respect to the corresponding filter and that of the beams emitted by each kind of primary-color sub-pixels with respect to any other (K−1) kinds of non-corresponding filters is large than 9. The color of the beams emitted by a kind of elementary-color sub-pixels is defined as an elementary color, and a total of K′ kinds of elementary colors exist. The color of the beams emitted by a kind of primary-color sub-pixels is defined as a primary color, and a total of K kinds of primary colors exist. The display device 10 shown in the FIG. 2 has K′=3 kinds of elementary-color sub-pixels, which also has K=3 kinds of primary-color sub-pixels. The 3 sub-pixels of each pixel are arranged along the x direction. FIG. 2 shows an example that sub-pixels emitting light of a same color are divided into 2 sub-pixel groups, and that a total of 2×3=6 sub-pixel groups exist: red sub-pixel group 1, green sub-pixel group 1, blue sub-pixel group 1, red sub-pixel group 2, green sub-pixel group 2, and blue sub-pixel group 2. Guided by the beam control device 20, the 6 sub-pixel groups project 6 perspective views of the target object, passing through the 6 viewing zones VZ_{R1}, VZ_{G1}, VZ_{B1}, VZ_{R2}, VZ_{G2}, and VZ_{B2}, respectively. There exist one-to-one correspondences between the 6 viewing zones and the 6 sub-pixel groups. Each sub-pixel takes a viewing zone corresponding to the sub-pixel group which contains this sub-pixel as the corresponding viewing zone at a time-point. The image message projected by each sub-pixel is the target object's projection message along the direction of this sub-pixel's emitted beam. That is to say, the image displayed by one sub-pixel group is a perspective view of the target object to the corresponding viewing zone. It should be pointed out that the beam projected by each sub-pixel is of elementary color, and only the optical message of the elementary color can be projected by each sub-pixel. In the above-mentioned sentence “The image message loaded on each sub-pixel is the target object's projection message along the direction of this sub-pixel's emitted beam”, the “projection message” loaded on a sub-pixel refers to only the message component whose color is consistent with the color of this sub-pixel. This is also applicable to the following parts of this patent application. The interval between the adjacent viewing zones is designed small enough to make at least two perspective views enter a same pupil 50 through the corresponding at least two viewing zones. As shown in the FIG. 2, three beams from the blue sub-pixel group 1, the red sub-pixel group 2, and the green sub-pixel group 2 enter the pupil 50 through viewing zones VZ_{B1}, VZ_{R2}, and VZ_{G2}, respectively. For each object point to be displayed, for example the object point P of the FIG. 2, three beams 3, 4, 5 from three elementary-color sub-pixel groups superpose into a spatial light spot that the eye can focus on. Compared with the case where a pixel is taken as the basic display unit, the usage of a sub-pixel as the basic display unit and the case that sub-pixels emitting lights of different colors are divided into different groups to project perspective views can increase the number of projected perspective views, also the number of the corresponding viewing zones. FIG. 2 is drawn to explain the basic principle of one-eye-multiple-view technologies with sub-pixels as basic display units, and no concrete structure gets involved. The beam control device 20 is replaced by a virtual frame, without considering its practical structure. Moreover, the spatial position of the beam control device 20 relative to the display device 10 is also drawn schematically in the FIG. 2. It does not mean that the actual position relation between the beam control device 20 and the display device 10 has to be identical to the case shown by the FIG. 2. With a same display device 10, the comparison between FIG. 1 and FIG. 2 indicates that using sub-pixels as the basic display units can increase the number of projected perspective views by K′−1=2 times under the condition that the projected perspective views are of a same resolution, relative to the case of using pixels as the basic display units. That is to say, without sacrificing the resolution of the projected perspective view and display frequency, the method declared in the present patent application can effectively increase the number of projected perspective views and corresponding viewing zones, compared with existing one-eye-multiple-view display methods using pixels as the basic display unit. A larger number of projected perspective views are benefit for the expansion of the viewing area, or the enlargement of the display depth through setting denser viewing zones.

The spatial light spot P shown in FIG. 2 is between the display device 10 and the viewer pupil 50, and is formed by superimposition of real beams from different sub-pixels. In fact, on the other side of the display device, spatial light spots can also be generated by superimposition of virtual beams. For example, at the point P′ of the FIG. 2, the virtual backward extension lines of light beams 6, 7, and 8 intersect. When the pupil 50 receives the light beams 6, 7, and 8, it can focus at the spatial light spot P′ which is the superimposition of the virtual backward beams of the beams 6, 7, and 8. The equivalent light distribution of each backward virtual beam can be simulated by diffraction propagation along the reverse direction. This kind of displayed spots are also called as superimposition spatial light spots, and they have a corresponding real image on the retina of the viewer's eye. In present patent application, the objects at two sides of the display device 10 are both displayed based on one-eye-multiple-view. In the following sections, the displayed object at the side near to the pupil 50 is often described as example.

Generating spatial light spots that the eye can focus at, the passing-through beams need to meet a premise. On the pupil plane, the size of the light distribution area of a passing-through beam where the light intensity value is greater than 50% of the peak light intensity should be smaller than the diameter of the pupil 50 along at least one direction. This premise makes a superimposition spatial light spot having greater attraction to the eye's focus than the sub-pixels. The beam from a sub-pixel reaches the pupil plane through the corresponding viewing zone. The viewing zone corresponding to a sub-pixel is the viewing zone corresponding to a sub-pixel group which contains this sub-pixel. The preferred viewing zone of a sub-pixel group is the common region where all beams from this sub-pixel group can pass through. A viewing zone has two kinds of shapes. In the first case, in one direction, the size of the viewing zone is smaller than the diameter Dₚ of the pupil 50, but along other direction, the size of the viewing zone may be not smaller than Dₚ. This kind of viewing zone is called stripy viewing zone. In the other case, the size of the viewing zone is smaller than the diameter Dₚ of the pupil 50 along any direction. This kind of viewing zone is called spotty viewing zones. For the stripy viewing zone, arrangement along one direction should be implemented. For spotty viewing zones, one-dimension arrangement and two-dimension arrangement are both feasible.

In FIG. 2, the pupil 50 is placed close to the plane where the viewing zones are located. When the pupil 50 deviates forward or backward from the plane of the viewing zones, the pupil 50 becomes unable to receive all beams of the at least two perspective views. As shown in FIG. 3, the whole perspective view passing through the viewing zone VZ_{B1} is observable for the pupil 50. This perspective view is projected by the corresponding blue sub-pixel group 1. However, the pupil 50 can only perceive beams from sub-pixels in Mₛ₂Mᵣ₁ region of the red sub-pixel group 2 through the viewing zone VZ_{R2} and beams from sub-pixels in Mₛ₁Mᵣ₂ region of the green sub-pixel group 1 through the viewing zone VZ_{G1}. Mₚ₁ and Mₚ₂ are the two marginal points of the pupil 50 along the viewing zone arrangement direction x, Mₛ₁ and Mₛ₂ are the two marginal sub-pixels of the display device 10 along the x direction. Mᵣ₁ is the intersecting point between the display device 10 and the line connecting point Mₚ₂ and side point of viewing zone VZ_{R2}. Mᵣ₂ is the intersecting point between the display device 10 and the line connecting point Mₚ₁ and side point of viewing zone VZ^{G1}. The Mₛ₂Mᵣ₁ area and the Mₛ₁Mᵣ₂ area are partially superposed in the area Mᵣ₁Mᵣ₂. Take their Mₛ₂M^{t} segment and MₜMₛ₁ segment, respectively. The two segments are mutually complementary. They join together. The sub-pixels on the Mₛ₂Mₜ segment of the red sub-pixel group 2 and the sub-pixels on the MₜMₛ₁ segment of the green sub-pixel group 1 tile into a composite sub-pixel group, with the optical message loaded on it named as a composite perspective view. The composite perspective view is also an image of the target object. Among them, Mₜ is a point in the superposing area Mᵣ₁Mᵣ₂. The pupil 50 at the position shown in FIG. 3 can receive the message from a perspective view and a composite perspective view. Within a certain depth range, spatial light spots that the pupil 50 can focus on get displayed based on one-eye-multiple-view. Obviously, with the pupil 50 being farther from the viewing zones, the composite sub-pixel group presenting composite perspective view perceived by the pupil 50 will be tiled by different parts of more sub-pixel groups.

In existing display technologies, color light is often presented through the combination of multiple elementary colors. The color beam from a pixel of a display device is achieved by hybrid of the K′ elementary color beams from the its sub-pixels (K′≥2). The K′ elementary colors in a common display device is often R (red), G (green), B (blue) corresponding to K′=K=3, or R, G, B, W (white) corresponding to K′=4 and K=3. When only fewest two passing-through beams from two sub-pixels are employed to superpose into a spatial light spot for one-eye-multiple-view display as above mentioned, the presentation of the color is inaccurate because of the lack of elementary colors. Considering the accurate presentation of color, when performing one-eye-multiple-view display, the superposed beams passing through a displayed spatial light spot and perceived by the pupil 50 are optimally to be at least K′ beams of different elementary colors. That is to say, at least K′ perspective views or/and composite perspective views of K′ elementary colors being perceived by a pupil is preferred. Along the arrangement direction of the viewing zones, the colors of the beams passing through the adjacent K′ viewing zones respectively correspond to K′ elementary colors is a common design.

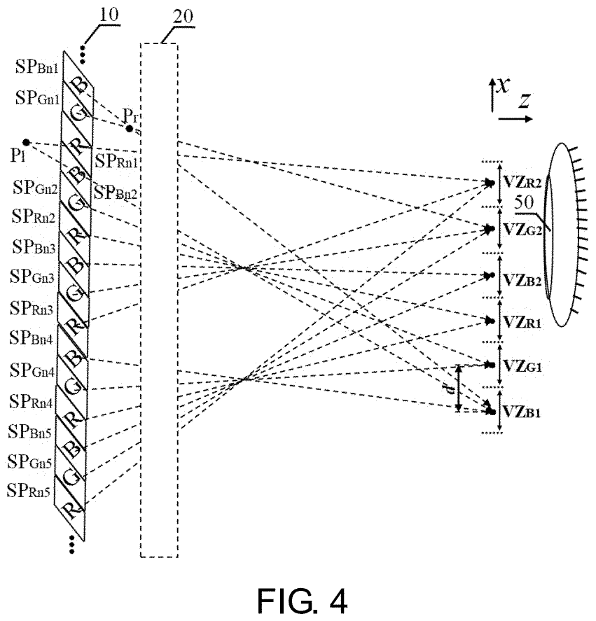

It should be noted that, even if the pupil 50 has received at least K′ perspective views or/and composite perspective views of K′ elementary colors, there exists a range near the display device 10 where the number of passing-through beams for a point is less than K′. This is due to the discrete distribution of the sub-pixels and the viewing zones. In the case of the arrangement of the sub-pixels and the viewing zones as shown in FIG. 4, the points Pᵣ and P₁ are such points with the number of passing-through beams being less than K′. These kinds of points spatially locate near the display device 10, and the visual discomfort caused by the vergence-accommodation conflict in this zone is relatively minor. This kind of points will not be considered and discussed in the following sections.

In the FIG. 2, there is a gap between adjacent viewing zones. In fact, adjacent viewing zones can also be arranged seamlessly or partially superposing. The following sections often use a seamless arrangement, but this does not mean that adjacent viewing zones must be arranged in such ways.

When the sub-pixels are used as the display units for one-eye-multiple-view display, the tracking device 70 shown in FIG. 2 can also be used to obtain the real-time position of the pupil 50. Firstly, when the beam from a sub-pixel is with a size larger than the diameter Dₚ along a certain direction, the position message of the pupil can help to choose the beam's propagating direction along a vector intersecting with the pupil 50. Secondly, when the pupil 50 does some movements, the control apparatus 30 can dynamically determine the sub-pixel groups whose emitted beams can enter the pupil 50 according to the pupil's real-time position. Then take these sub-pixel groups as the effective sub-pixel groups, with other sub-pixels inactive.

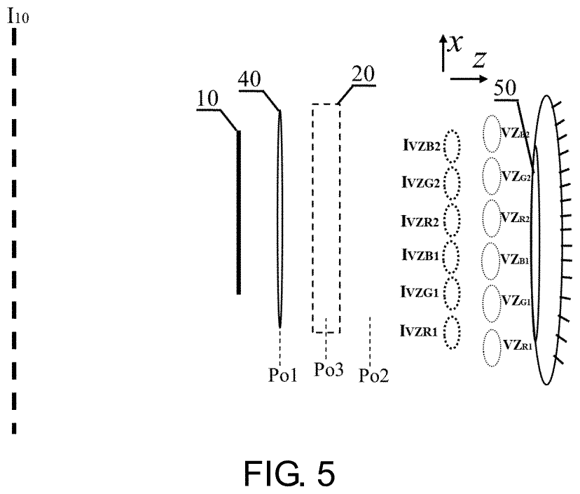

When the number of viewing zones is large enough and dense enough for respectively projecting at least two perspective views, or at least two composite perspective views, or at least one perspective view and one composite perspective view to each of the viewer's two pupils, the optical structure to implement the three-dimensional display method based on spatial superposition of sub-pixels' emitted beams can be used as a binocular optical engine. If the number of viewing zones only support projecting at least two perspective views, or at least two composite perspective views, or at least one perspective view and one composite perspective view to a single pupil, the optical structure to implement the three-dimensional display method based on spatial superposition of sub-pixels' emitted beams can only be used as a monocular optical engine, such as an eyepiece for head-mounted virtual reality (VR)/augmented reality (AR). Under this condition, the projection device 40 may be introduced to project the enlarged image I₁₀ of the display device 10, as shown in FIG. 5. The image I₁₀ of the display device 10 which is projected by projection device 40 can be taken as an equivalent display device composed of equivalent sub-pixel groups. Each equivalent sub-pixel group is an image of the corresponding sub-pixel group on the display device 10. When the image of a viewing zone projected by projection device 40 which corresponds to a sub-pixel group on the display device 10 exists, a viewing-zone image can be taken as the equivalent viewing zone corresponding to an equivalent sub-pixel group. For example, the equivalent viewing zone I_{VZR2} of FIG. 5, which is the image of the viewing zone VZ_{R2}, corresponds to the equivalent red sub-pixel group 2 which is the image of the red sub-pixel group 2. Actually, when the projection device 40 is introduced in, an equivalent sub-pixel group and its corresponding equivalent viewing zone play the same function as that of a sub-pixel group and its corresponding viewing zone when the projection device is not introduced in. In addition, the position of the projection device 40 relative to the beam control device 20 depends on the specific structure of the beam control device 20. The projection device 40 can also be placed at the position Pₒ₂ shown in the FIG. 5 or the position Pₒ₃ between different components of a beam control device 20.

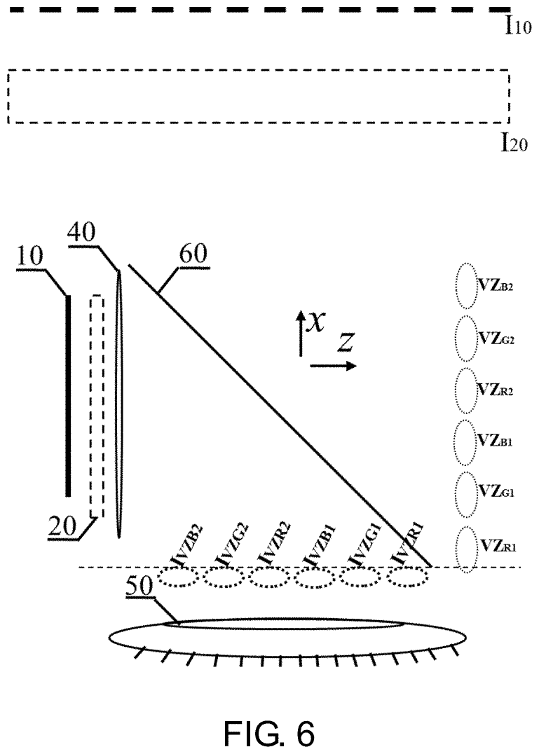

Furthermore, the relay device 60 can be used to guide beams from the display device 10 to the viewing zones by deflection, refraction, or other methods. In FIG. 6, a semi-transparent and semi-reflective surface is taken as the relay device 60. Under this condition, the equivalent display device is the image of the display device 10 with respect to the projection device 40 and the relay device 60, such as the I₁₀ in FIG. 6. An equivalent sub-pixel group is the image of a sub-pixel group with respect to the projection device 40 and the relay device 60. Similarly, the equivalent viewing zones is also the images of the corresponding viewing zones, such as the I_{VZR1}, I_{VZB1}, etc., shown in FIG. 6. The position relation among beam control device 20, projection device 40 and relay device 60 is also schematically shown.

When an optical structure functions as a monocular optical engine, two such structures for two pupils are often needed. In all the figures discussed above, for simplicity, the display device 10 is drawn as a thin structure. Actually, the display device 10 can be an active display device or a passive display device with backlights. FIGS. 1 to 6 do not relate to the specific structure of the beam control device 20, and a virtual frame is used to represent the beam control device 20. In addition, the spatial position of the beam control device 20 relative to the display device 10 is only schematically shown in the FIG. 1 to FIG. 6.

In the following sections, taking a specific device to function as the beam control device 20, three-dimensional display method based on superposition of sub-pixels' emitted beams disclosed in this patent application is further exemplified and explained.

### Embodiment 1

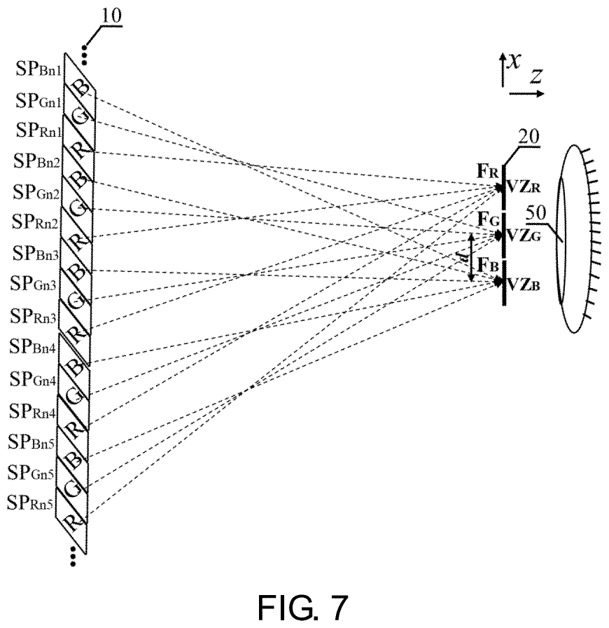

An aperture array is used as the beam control device 20, which is placed corresponding to the display device 10, as shown in FIG. 7. This kind of beam control device is named as aperture-type beam control device 20 in the present patent application. The display device 10 takes a common RGB display panel as an example. Each pixel is composed of three sub-pixels that emit R, G, and B lights, respectively. The sub-pixels of a pixel are arranged along the x direction. Along the y direction that is perpendicular to the x direction, the sub-pixels that emit the same color light are arranged adjacent to one another successively. FIG. 7 only takes a row of sub-pixels in the x direction as an example, and each sub-pixel is marked by their emitted light colors R, G, and B, respectively. For example, the sub-pixel SP_{Bn1} has a subscript B to denote that it emits blue light. The K′=3 kinds of elementary-color sub-pixels are also K=K′=3 kinds of primary-color sub-pixels. They correspond to the red filter, green filter and blue filter, respectively. The sub-pixels that emit light of the same color construct a sub-pixel group. That is to say, all the sub-pixels of the display device 10 are divided into a red sub-pixel group, a green sub-pixel group, and a blue sub-pixel group. Along the light propagation direction of the beams from the display device 10, an aperture array of K′=3 apertures is placed as the beam control device 20. The K′=3 apertures are attached by a red filter F_{R}, a green filter F_{G}, and a blue filter F_{B}, respectively. Then, the beams from the red sub-pixel group only can pass through the corresponding aperture with the red filter F_{R}, the beams from the green sub-pixel group only can pass through the corresponding aperture with the green filter F_{G}, and the beams from the blue sub-pixel group can pass through the corresponding aperture with the blue filter F_{B}. In this patent application, a ratio between transmittance of the beams emitted by each kind of primary-color sub-pixels with respect to the corresponding filter and that of the beams emitted by each kind of primary-color sub-pixels with respect to any other (K−1) kinds of non-corresponding filters is large than 9. Under this condition, the noise of light passing through apertures with non-corresponding filters is small. In the following sections, this kind of noise will not be considered, and an aperture with a filter is supposed to be transparent only to beams of the corresponding color. So, the aperture with the red filter F_{R} is the viewing zone VZ_{R} corresponding to the red sub-pixel group, and the subscript R indicates that the viewing zone is attached by a red filter F_{R}. Similarly, the aperture with the green filter F_{G} is the viewing zone VZ_{G} corresponding to the green sub-pixel group, and the subscript G indicates that the viewing zone is attached by a green filter F_{G}. And the aperture with the blue filter F_{B} is the viewing zone VZ_{B} corresponding to the blue sub-pixel group, and the subscript B indicates that the viewing zone is attached by a blue filter F_{B}. With a subscript indicating the type of attached filter is also used in the following part of this embodiment. According to the principle shown by the FIG. 2, when the distance between adjacent viewing zones is sufficiently small, at least two perspective views or/and composite perspective views can be observed by the pupil 50 for one-eye-multiple-views display.

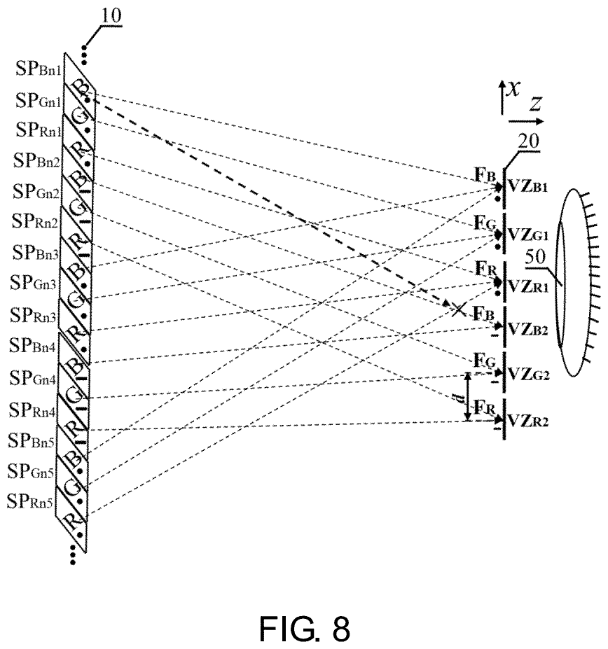

For accurate presentation of the colors, at least three primary-color perspective views are preferred to enter the pupil 50. When only K′=3 viewing zones get presented, the pupil 50 has to be restricted to a small region around the K′=3 viewing zones. More viewing zones are expected to provide wider space for the pupil 50's movement. Introducing orthogonal characteristics to the aperture-type beam control device 20 can effectively solve this problem. The orthogonal characteristics can be two polarization states with orthogonal linear polarization directions. As shown in FIG. 8, the aperture-type beam control device 20 contains M=2 aperture groups, each of which contains K′=K=3 apertures attached by a red filter F_{R}, a green filter F_{G}, and a blue filter F_{B}, respectively. At the same time, the M=2 aperture groups allow lights with mutually orthogonal linear polarization directions (i.e., lights in two polarization states) passing through, respectively. The two polarization states are denoted by “−” and “⋅” in the figure, respectively. Specifically, the viewing zones VZ_{B1}, VZ_{G1}, and VZ_{R1} only allow blue, green, and red “⋅” light passing through, respectively. And the viewing zones VZ_{B2}, VZ_{G2}, and VZ_{R2} only allow blue, green, and red “−” light passing through, respectively. Here, the transparency only to polarization states “−” or “⋅” can be implemented by attaching a polarizer to the corresponding aperture. All sub-pixels that emit light of the same color are correspondingly spatially divided into M=2 groups, which are named as spatial-characteristics sub-pixels in the patent application, one group only emitting “⋅” light, and the other group only emitting “−” light. For example, in FIG. 8, the sub-pixels SP_{Bn1}, SP_{Bn3}, SP_{Bn5}, . . . constitute the spatial-characteristics blue sub-pixel group 1, and the sub-pixels SP_{Bn2}, SP_{Bn4}, . . . constitute the spatial-characteristics blue sub-pixel group 2. In order to ensure that the sub-pixels of each spatial-characteristics sub-pixel group are arranged throughout the display device 10, an interlacing arrangement of sub-pixels of different spatial-characteristics sub-pixel groups emitting the same color light is preferred. As shown in FIG. 8, the adjacent M=2 sub-pixels of the same color along x direction belong to different spatial-characteristics sub-pixel groups.

Thus, there exists a one-to-one correspondence between K′×M=3×2=6 spatial-characteristics sub-pixel groups and the 6 apertures. An aperture serves as the viewing zone of the corresponding spatial-characteristics sub-pixel group, and only allows the beams from the corresponding spatial-characteristics sub-pixel group passing through. The two polarization states with orthogonal linear polarization directions shown in the FIG. 8 can also be replaced by the left-handed circular polarization and the right-handed circular polarization. The viewing zones shown in the FIG. 7 or FIG. 8 can be attached to the corresponding pupil as a contact lens.

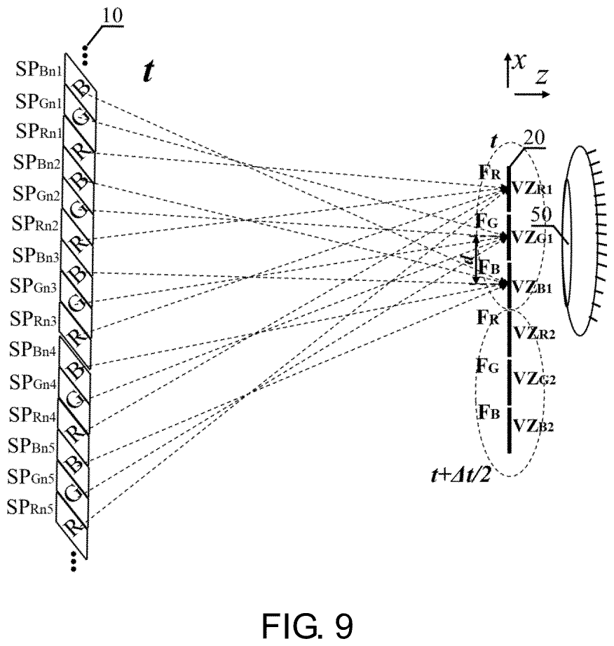

The orthogonal characteristics can also be temporal orthogonal characteristics that permitting the incident light passing through at different time-points sequentially. As shown in the FIG. 9, the aperture array contains M=2 aperture groups, and each aperture group contains K=3 apertures with a red filter F_{R}, a green filter F_{G}, and a blue filter F_{B} being attached, respectively. The M=2 aperture groups get turned on at two different time-points t and t+Δt/2 of a time period t˜t+Δt, respectively, controlled by the control apparatus 30. Specifically, the apertures VZ_{B1}, VZ_{G1}, and VZ_{R1} are turned on at the time-point t, and the apertures VZ_{B2}, VZ_{G2}, and VZ_{R2} are turned on at the time-point t+Δt/2. FIG. 9 shows the corresponding situation at time-point t. The sub-pixels that emit the same color light are divided into two temporal-characteristics sub-pixel groups. The two temporal-characteristics sub-pixel groups are constructed by identical sub-pixels, but project perspective views at different time-points of a time period. At different time-points of a time period, the corresponding viewing zones of the temporal-characteristics sub-pixel groups are different. For example, at time-point t, the temporal-characteristics blue sub-pixel group 1 composed of SP_{Bn1}, SP_{Bn2}, SP_{Bn3}, . . . takes the aperture VZ_{B1} as the corresponding viewing zone, and at time-point t+Δt/2, the temporal-characteristics blue sub-pixel group 2 which is also composed of SP_{Bn1}, SP_{Bn2}, SP_{Bn3}, . . . takes the aperture VZ_{B2} as the corresponding viewing zone. So, K′×M=6 viewing zones get presented. A larger M requires the display device 10 having a higher frame rate to avoid the flicker effects. In FIGS. 8 and 9, under the premise of projecting at least K′ elementary color perspective views or/and composite perspective views to a same pupil 50, the spatial positions of the viewing zones can be interchanged. The aperture-type beam control device 20 with temporal characteristics can be an electronic control liquid crystal panel connecting with the control apparatus 30.

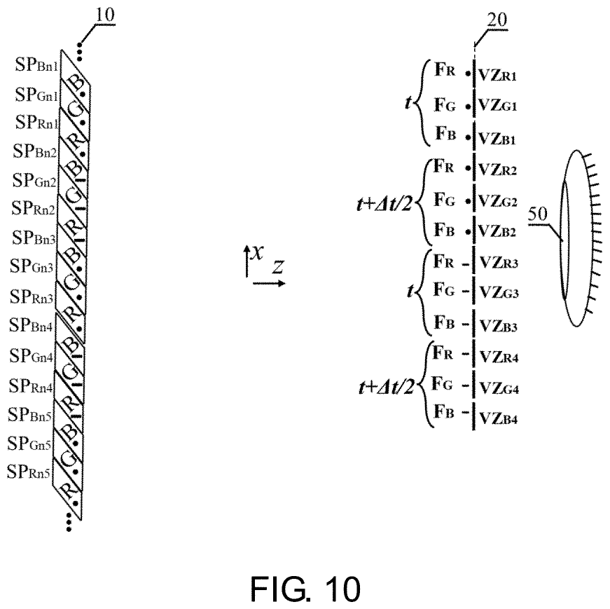

Furthermore, the above mentioned orthogonal characteristic can also be hybrid characteristics, for example, a combination of temporal orthogonal characteristics and polarization orthogonality (such as two polarization states with orthogonal linear polarization directions). As shown in FIG. 10, the apertures VZ_{R1}, VZ_{G1}, and VZ_{B1} that only allow “⋅” light passing through are turned on only at the time-point t of a time period t˜t+Δt, which get turned off at time-point t+Δt/2, and the apertures VZ_{R2}, VZ_{G2}, and VZ_{B2} that only allow “⋅” light passing through are turned on only at the time-point t+Δt/2 of the time period t˜t+Δt, which get turned off at time-point t. Similarly, the apertures VZ_{R3}, VZ_{G3}, and VZ_{B3} that only allow “−” light passing through are turned on only at the time-point t of a time period t˜t+Δt, which get turned off at time-point t+Δt/2, and the apertures VZ_{R4}, VZ_{G4}, and VZ_{B24} that only allow “−” light passing through are turned on only at the time-point t+Δt/2 of the time period t˜t+Δt, which get turned off at time-point t. Correspondingly, the sub-pixels emitting light of the same color are spatially divided into two spatial-characteristics sub-pixel groups. Then, each spatial-characteristics sub-pixel group projects a different perspective view to a different viewing zone at two time-points of a time period, functioning as two hybrid-characteristics sub-pixel groups. Then, within a time period t˜t+Δt, the four mutually independent hybrid-characteristics sub-pixel groups which emit light of the same color can project four perspective views to the corresponding four viewing zones, respectively. Totally, 12 viewing zones get generated. Repeat this process during other time periods. Based on the persistence of vision, the 12 viewing zones can provide perspective views with denser angular density to the pupil 50 and a larger observing space.

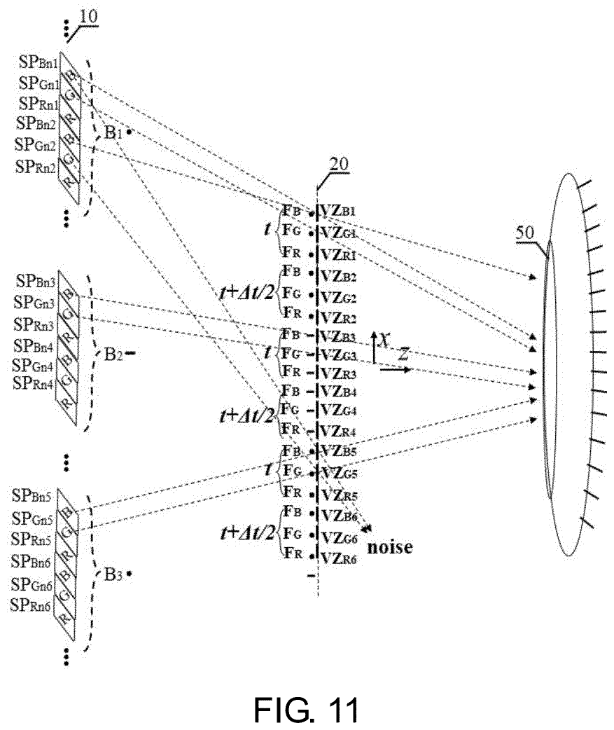

There is another setting manner of the hybrid-characteristics apertures, as shown in FIG. 11. The display device 10 is divided into BN blocks along the x direction (BN≥2). Here BN=3 is taken as an example. Beams from adjacent blocks are set with mutually orthogonal characteristics. For example, the sub-pixels in the block B₁ all emit “⋅” light, the sub-pixels in the block B₂ all emit “−” light, and the sub-pixels in the block B₃ all emit “⋅” light. All the sub-pixels emitting light of a same color construct a sub-pixel group. So, sub-pixels in adjacent blocks of a same sub-pixel group emitted light with orthogonal linear polarization directions. For a sub-pixel group, different apertures are assigned to sub-pixels in different blocks. The blue sub-pixel group consisting of all the sub-pixels emitting light of blue color is taken as an example. The apertures VZ_{B1}, VZ_{B3}, and VZ_{B5}, which are turned on only at time-point t of the time period t˜t+Δt, permit light of “⋅”, “−”, and “⋅” passing through, respectively. The apertures VZ_{B2}, VZ_{B4}, and VZ_{B6}, which are turned on only at time-point t+Δt/2 of the time period t˜t+Δt, permit light of “⋅”, “−”, and “⋅” passing through, respectively. At time-point t, the blue sub-pixels in the block B₁ take the VZ_{B1} as the corresponding viewing zone, the blue sub-pixels in the block B₂ take the VZ_{B3} as the corresponding viewing zone, and the blue sub-pixels in the block B₃ take the VZ_{B5} as the corresponding viewing zone. At time-point t+Δt/2, the blue sub-pixels in the block B₁ take the VZ_{B2} as the corresponding viewing zone, the blue sub-pixels in the block B₂ take the VZ_{B4} as the corresponding viewing zone, and the blue sub-pixels in the block B₃ take the VZ_{B56} as the corresponding viewing zone. Thus, the blue sub-pixels in different blocks project optical message through different corresponding viewing zones at a time-point. That is to say, the spatial size of the display panel for a viewing zone becomes smaller, and multiple viewing zones are employed for perceiving messages loaded on a whole sub-pixel group. This designment can alleviate the limitation on the field of view when small size apertures are employed. At a time-point, each sub-pixel group performs message projection through corresponding BN=3 apertures. In this designment, BN (≥2) viewing zones are needed for each sub-pixel group, each sub-pixel of which takes one of the BN viewing zones as the corresponding viewing zone. Due to the very limited attainable number of orthogonal characteristics, for example there are only two polarization states with orthogonal linear polarization directions, beams from a block may pass through a non-corresponding viewing zone as noise, such as the light from sub-pixel SP_{Bn1} through the non-corresponding viewing zone VZ_{B5} at time-point t. When non-corresponding viewing zones which permit light from a pixel passing through as noise are designed to have a spacing large enough away from this sub-pixel's viewing zone, the noise can be guided to miss the pupil 50. As shown in FIG. 11, for a blue sub-pixel of the block B1, there exist 11 viewing zones between the corresponding viewing zone VZ_{B1} and the non-corresponding viewing zone VZ_{B5} at the time-point t. The displayed message by the blue sub-pixels of the block B1, such as the light from the sub-pixel SP_{Bn1}, is designed to present to the pupil 50 through the corresponding viewing zone VZ_{B1} The light from the sub-pixel SP_{Bn1} can also pass through the non-responding viewing zone VZ_{B5} as noise, but the noise can not enter the pupil 50 due to a relatively large interval between the VZ_{B1} and the VZ_{B5}.

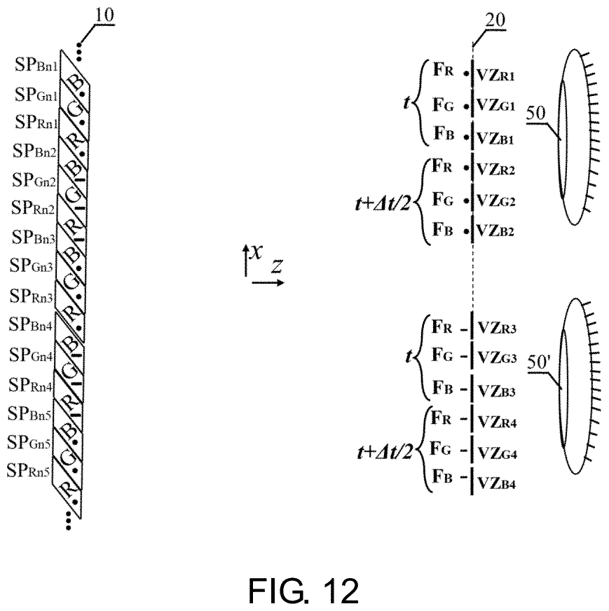

The viewing zones shown in FIGS. 8 to 11, i.e. the apertures of the aperture-type beam control device 20, can be divided into two groups. The two groups are responsible for the left pupil 50′ and right pupil 50 of the viewer, respectively, as shown in the FIG. 12. The method described above can be directly applied to the two eyes of a viewer. Furthermore, when the number of groups gets increased for more eyes of more viewers, multiple-viewer display can be implemented.

In the above figures, the aperture can take a long strip shape, which can only be arranged in one-dimensional direction. Along the arrangement direction, the size of each aperture is smaller than the diameter Dₚ of the pupil 50. In some other directions, the size of the stripy aperture can be greater than the diameter Dₚ. In another case, the aperture is spotty, which is smaller than the diameter Dₚ along any directions. When spotty apertures are used, the apertures shown in above figures can be extended to be arranged at a two-dimensional surface.

In the above figures, adjacent sub-pixels are shown separated from each other. In fact, the K′ elementary color sub-pixels of each pixel can also be spatially superposed, such as a display device 10 with K′ kinds of color backlights being projected onto a common sub-pixel sequentially by the color wheel. Under this condition, in the display process, more time points are needed. For example, the time segment t˜t+Δt/2, should be further divided into K′ sub-time-periods for sequential incident of the K′ color backlights. Such display process with time segment t˜t+Δt/2 being divided into K′ sub-time-periods equivalent to that K′ sub-pixels with different colors sequentially project corresponding optical message.

When a primary-color object is to be displayed, designing K′=3 perspective views with different primary colors for a same pupil 50 will result in that only one perspective view of the object's primary color is actually presented to the eye. That is to say, the one-eye-multiple-view display fails to get implemented. To solve this problem, the primary-color object can be replaced by an object with original color+χ(White)=original color+χ(R+G+B), where χ<1.

A display device 10 with K′=K=3 is taken as example for the above description. Actually, the values of K′ and K can be different. For example, the display device with four kinds of sub-pixels of R, G, B and W (white) can also be employed for the one-eye-multiple-view display, with K′=4 and K=3. Light from the white sub-pixels can pass through the filters corresponding to the other K=3 kinds of primary colors. Under this condition, the aperture corresponding to the non-primary-color sub-pixel group should be with a different orthogonal characteristic from those of other apertures corresponding to the primary-color sub-pixel groups. For example, the white sub-pixel group projects beams at a time-point different with other primary-color sub-pixel groups within a time period, accompanied by the synchronous turning-on or turning-off of the corresponding apertures. For example, the beams from white sub-pixels and the other primary-color sub-pixels are designed to be with left-handed circular polarization and right-handed circular polarization, respectively. Correspondingly, the apertures are also designed only allowing light with corresponding characteristics passing through.

In addition, the method declared in the present patent application does not restrain the shape of the sub-pixels of the display device 10. For example, the sub-pixel of the display device can be with a rectangular shape, or a square shape. The arrangement mode of the sub-pixels can be the RGB arrangement mode shown in above figures, or other arrangements, such as the PenTile arrangement. In the above figures, the display device 10 is exemplified by a display with a thin structure. In fact, the display device 10 also can be other types of displays, such as a transmissive or reflective display with a thick structure that requires a backlight. Each aperture in the aperture-type beam control device 20 also can be a reflective-type aperture.

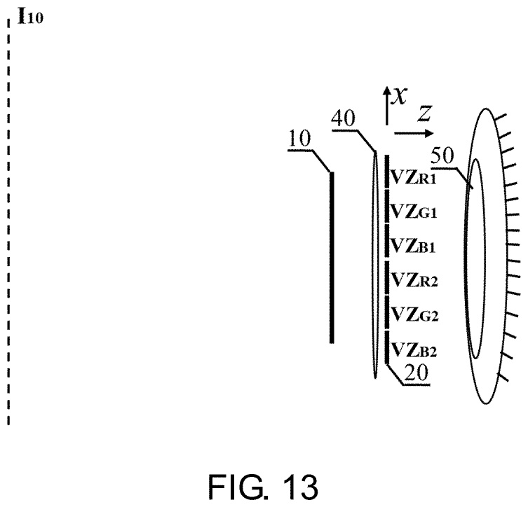

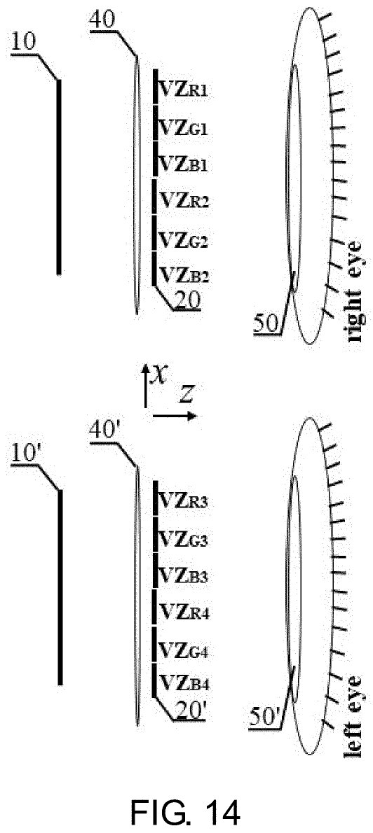

For the above structures shown in FIGS. 7 to 11, a projection device 40 can be introduced in, similar to the projection device 40 located at position Po1 shown in the FIG. 5. When adopting the aperture-type beam control device 20, the projection device 40 can be placed near to the control device 20, as shown in FIG. 13. The positions of the projection device 40 and the beam control device 20 in FIG. 13 can also be interchanged. In this case, the image I₁₀ of the display device 10 can be taken as an equivalent display device for one-eye-multiple-view display. FIG. 13 takes two groups of aperture groups as an example. It can also be only one group, or more groups. Apertures from different aperture groups have different orthogonal characteristics, such as the temporal orthogonal characteristics, or two polarization states of left-handed circular polarization and right-handed circular polarization, or hybrid characteristics. The structure with projection device 40 is often used as an eyepiece for a near-eye display optical engine. Two such eyepieces build a binocular display optical structure, as shown in FIG. 14.

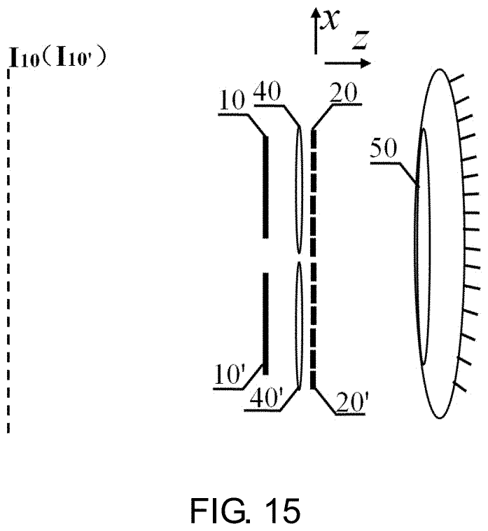

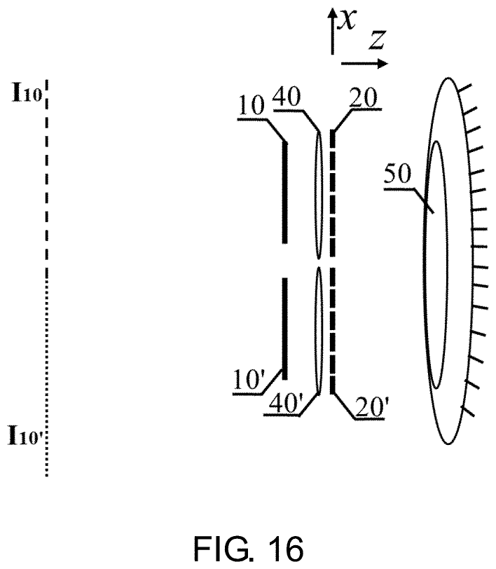

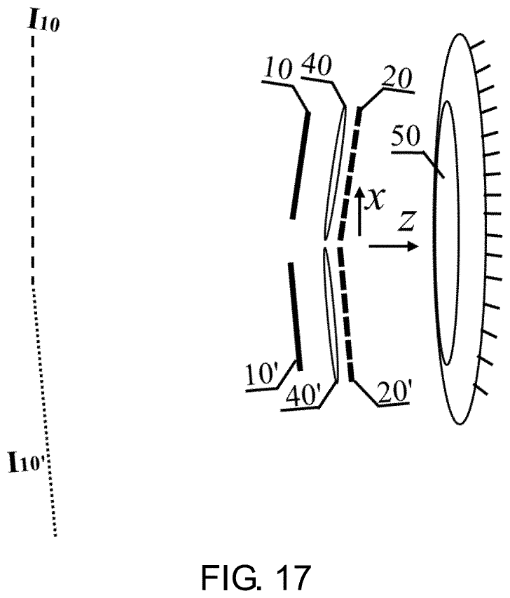

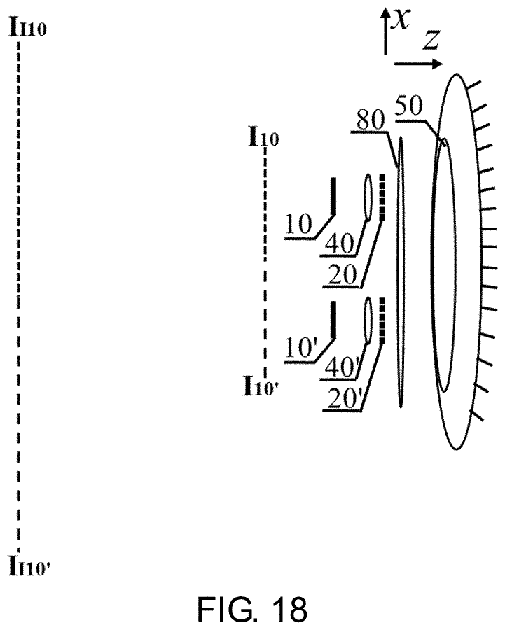

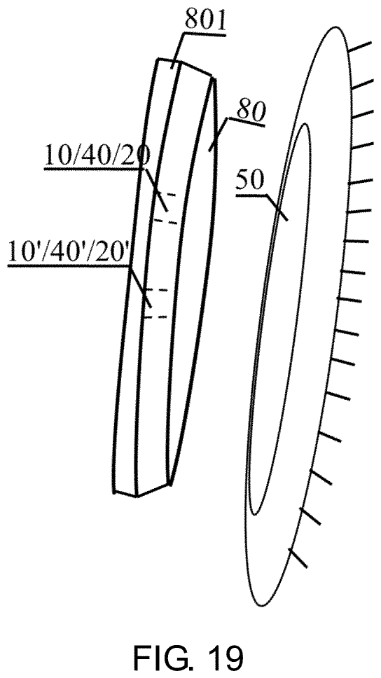

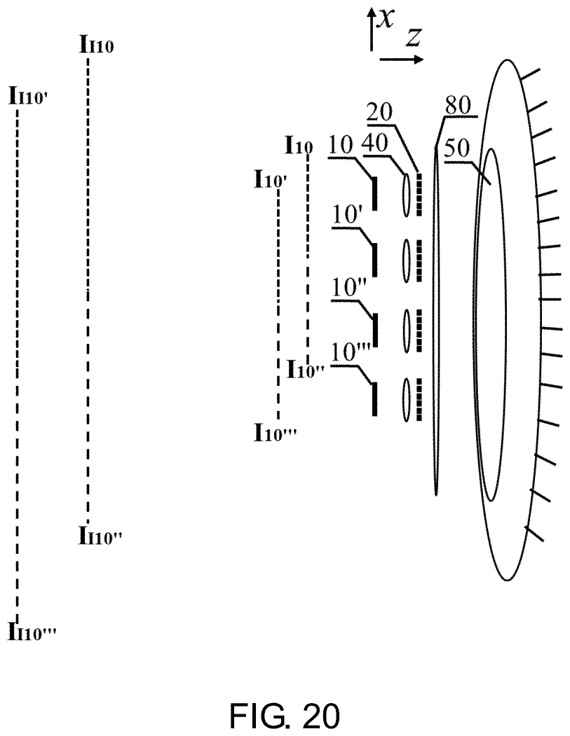

The structure shown in FIG. 13 can be further expanded into a composite structure for optimization of the display performance and the size of optical structure. The structure shown in FIG. 15 can improve the number and density of the viewing zones through superposing images of the two display devices. The structure shown in FIG. 16 enlarges the field of view by seamlessly splicing images of the two display devices into an image I₁₀+I₁₀′, which is called splicing image. FIG. 17 is similar to FIG. 16, except that the splicing of two images is along a curved plane. FIG. 18 introduces an auxiliary projection device 80, which projects the splicing image. As shown in FIG. 18, the image I₁₀ and the image I₁₀′ are combined into a splicing image I₁₀+I₁₀′, where image I₁₀ is the image of the display device 10 projected by the projection device 40, and image I₁₀′ is the image of the display device 10′ projected by the projection device 40′. The auxiliary projection device 80 images the splicing image I₁₀+I₁₀′ again to obtain an enlarged splicing image I_{I10}+I_{I10}′ formed by the image I_{I10} of the image I₁₀ and the image I_{I10′} of the image I₁₀′. The characteristics of the structure shown in FIG. 18 lie in that a combined structure consisting of a display device, a projection device, and a beam control device is compact when a small-size display device is used. Such as the combined structure consisting of the display device 10, the projection device 40, and the beam control device 20 of the FIG. 18. The compact combined structure can be hold by a hole of the thin eyepiece shown in FIG. 19 for a truly light and thin display structure. The compensation device 801 is used to eliminate the influence of the auxiliary projection device 80 on the incident ambient light, to guarantee the ambient light entering the pupil 50 with small distortion or even no distortion. The compensation device 801 can be removed when ambient light is not considered. Solid material, such as optical glass, is filled between the auxiliary projection device 80 and the compensation device 801 as bracing structure. Actually, in the combined structure consisting of the display device, the projection device, and the aperture-type beam control device, imaging of the slicing image is not the mandatory requirement. The auxiliary projection device 80 and compensation device 801 can be removed if necessary. Furthermore, more combined structures can project more splicing images at different depth. As shown in FIG. 20. The images of the display device 10 and the display device 10″ are tiled into a slicing image I₁₀+I₁₀″, and the images of the display device 10′ and the display device 10″′ are tiled into a slicing image I₁₀′+I₁₀′″. The two splicing images can be in superposing state or be separated along the depth direction. On the plane perpendicular to the depth direction, the two splicing images can be completely superposed, or be partially superposed. To show it more clearly, some components are not marked. The two splicing images in FIG. 20 are exemplified as partially superposed in the perpendicular plane and separation along the depth direction. The auxiliary projection device can also be placed between the projection device and the beam control device. The combined structures can also be arranged along a curved line, even at a two-dimensional plane or curved plane. The above figures also can contain more combined structures.

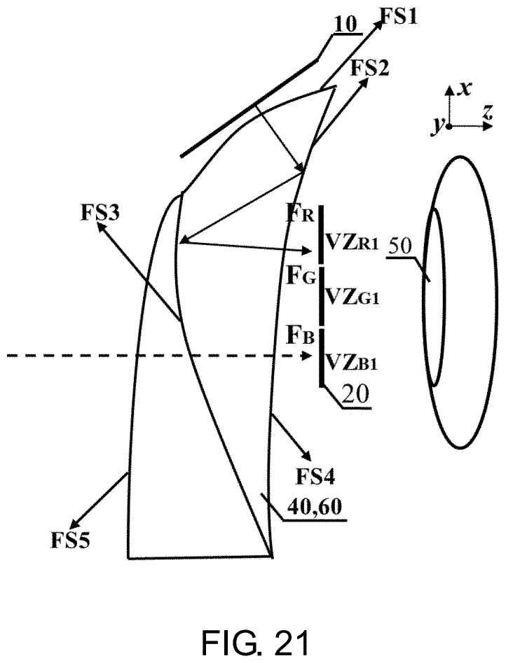

In the structure shown in FIG. 13, a relay device 60 can also be introduced in to guide the beams to the area around the the pupil 50 such as the semi-transparent and semi-reflective surface shown in the FIG. 6. The relay device 60 can use various optical devices. When the relay device 60 is composed of multiple components, it can be separated from the projection device 40, or share some common components with the projection device 40. The free-surface relay device 60 shown in FIG. 21 consists of a curved transmission surface FS1, a curved reflection surface FS2, a semi-transparent and semi-reflective surface FS3, a curved transmission surface FS4, and a curved transmission surface FS5. Among them, FS1, FS2, FS3, and FS4 together perform the function of a projection device 40, FS2 and FS3 together perform the function of a relay device 60, and FS5 plays a compensation function, allowing external ambient light to be perceived by the pupil 50 without being affected by FS3 and FS4.

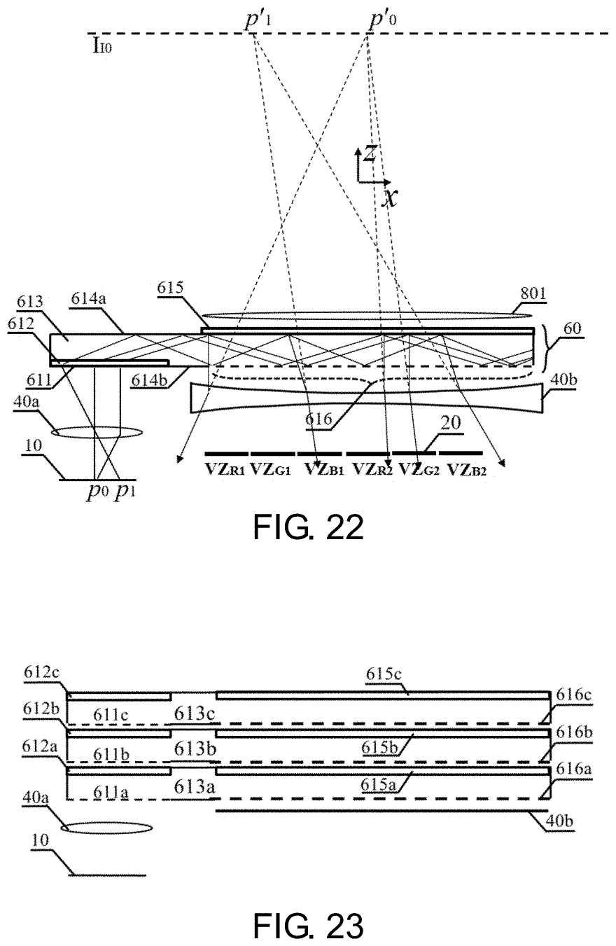

The relay device 60 also can be an optical waveguide device, which is called a waveguide-type relay device 60. In FIG. 22, the waveguide-type relay device 60 is placed between the display device 10 and the aperture-type beam control device 20, which consists of the entrance pupil 611, the coupling-in element 612, the waveguide 613 with two reflection surfaces 614a and 614b, the coupling-out element 615 and the exit pupil 616. The projection device 40 is a composite device consisting of a lens 40a and a lens 40b. Emitted light of a sub-pixel, such as sub-pixel p₀, is converted into parallel light through the lens 40a. Then the parallel light from the sub-pixel p₀ incidents on the coupling-in element 612 via the entrance pupil 611, and furtherly incidents on the coupling-out element 615 through the guidance of the coupling-in element 612 and the reflection of the reflection surfaces 614a and 614b. The coupling-out element element 615 modulates the incident light and guides it to incident on the lens 40b through the exit pupil 616. The lens 40b guides the light from the sub-pixel p₀ to the aperture-type beam control device 20 as divergent light from the virtual image p′₀ of the sub-pixel p₀. Similarly, p′₁ is the virtual image of the sub-pixel p₁. Images of sub-pixels such as p′₀ and p′₁ form the image I₁₀ of the display device 10. The coupling-out element 615 can have the pupil extending function. The incident light on the coupling-out element 615 with the pupil extending function is partially guided to the exit pupil, with the other part keeping propagating in the waveguide 613 to incident on the other segment of the coupling-out element 615 once again. Repeating this process furtherly enlarges the exit pupil 616. Then, with the image I₁₀ as an equivalent display device, one-eye-multiple-view can get implemented. The compensation device 801 is used to counteract the influence of the lens 40b on the incident light from outside environment, and can also be removed when light from outside environment is not needed. The lens 40b can also be integrated into the coupling-out element 615. For example, a holographic device can play the functions of both the coupling-out element 615 and the lens 40b of the FIG. 22, as a composite coupling-out element 615. When the composite coupling-out element 615 is with the angular-selectivity characteristics, it can modulate only the beams from the the coupling-in element 612, with no influence on the beams from the outside environment. Under this condition, the compensation device 801 can be removed. The FIG. 22 takes a common optical waveguide device as example. Existing optical waveguide devices with various structures also can be used as the waveguide-type relay device 60, such as the optical waveguide device with multiple semi-transparent semi-reflective surfaces as the coupling-out element 615. Considering the dispersion, a stack structure constructed by stacking multiple optical waveguide devices also can be employed as the waveguide-type relay device 60, with each optical waveguide device named as an element optical waveguide device. As shown in FIG. 23, the three element optical waveguide devices respond for the propagation and guidance of R, G, and B lights from the display device 10, respectively.

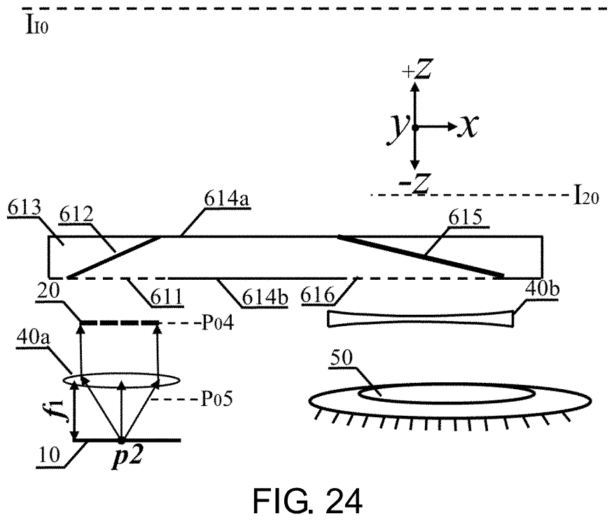

In the structure shown in FIG. 22, the waveguide-type relay device 60 is placed between the display device 10 and the aperture-type beam control device 20. The waveguide-type relay device 60 also can be placed in front of the aperture-type beam control device 20 along the beam propagation direction, as shown in FIG. 24. The light emitting from each sub-pixel is converted into parallel light by the lens 40a, and then incidents on the aperture-type beam control device 20. The beams passing through the beam control device 20 enter the waveguide-type relay device 60 through the entrance pupil 611. The coupling-out element element 615 modulates the incident lights and guides the incident lights to incident on the lens 40b through the exit pupil 616. The lens 40b guides the lights from each sub-pixel to the aperture-type beam control device 20. The lights from each sub-pixel gets modulated by the lens 40b and are converged in reversed direction to construct the virtual image I₁₀ of the display device 10. The transmitted light at each point on the aperture-type beam control device 20 is divergent. In order to ensure that the light from each sub-pixel to enter the pupil 50 as one beams along a corresponding direction, it is required that only a unique image of each point of the aperture-type beam control device 20 exists when the transmitted light passes through the waveguide-type relay device 60 and the lens 40b. This also means that there exists a unique image I₂₀ of the aperture-type beam control device 20. The position for the I₂₀ depends on the specific parameters of the optical structure, such as the positions shown in the FIG. 24. With the image I₁₀ as an equivalent display device and the image of each aperture on the image I₂₀ as an equivalent viewing zone, one-eye-multiple-view can be implemented. Under this condition, the waveguide-type relay device 60 with pupil expansion function will lead to multiple images of the aperture-type beam control device 20. To avoid perceiving beams that pass through different images of an aperture synchronously by the pupil 50, the beams coming from a sub-pixel and passing through adjacent images of an aperture should be designed with an intersection angle large enough. A tracking device 70 is needed to determines the real-time position of the pupil 50. The control apparatus 30 determines the effective beam perceived by the pupil 50 from each sub-pixel according to the real-time position of the pupil 50. The loaded message of a sub-pixel is the projection message of the target object along the direction of this effective beam. In the figure, the aperture-type beam control device 20 also can be placed at the position Po5. FIG. 24 takes two reflecting surfaces as the coupling-in element 612 and the coupling-out element 615, respectively. The optical waveguide device shown in the FIG. 22, or other kinds of optical waveguide devices also can be used in FIG. 24. The compensation device 801 also can be introduced in, and the lens 40b can be integrated into a composite coupling-out element 615.

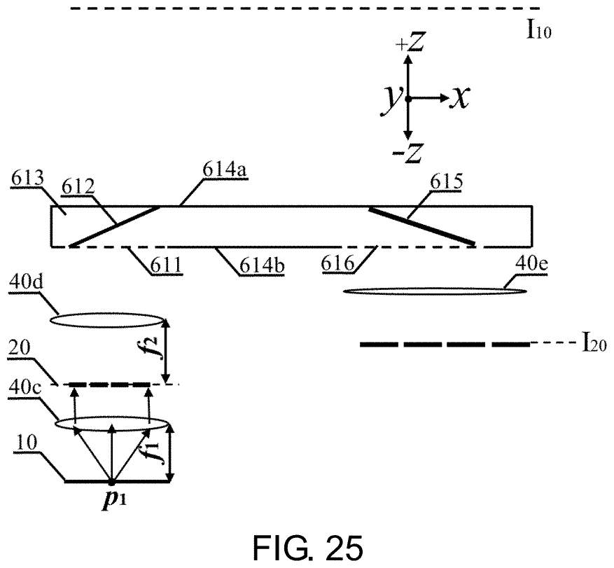

When the waveguide-type relay device 60 is placed in front of the aperture-type beam control device 20 along the propagation direction of light, transmission light of a point on the aperture-type beam control device 20 can also be designed to enter the waveguide-type relay device 60 as parallel light. For example, lenses 40c, 40d, and 40e construct the projection device 40 as shown in FIG. 25. Then, modulated by the lens 40c and 40d, the relay device 60, and the lens 40e, image I₂₀ of the aperture-type beam control device 20 is generated. The light from each sub-pixel propagates as parallel light behind the lens 40c, and light passing through a point on the aperture-type beam appear as parallel light behind the lens 40d and incident on the relay device 60. Then, image I₂₀ of the aperture-type beam control device 20 gets presented at the focal plane of the lens 40e since the parallel light from each points of the aperture-type beam control device 20 are converged by the lens 40e. The waveguide-type relay device 60 with pupil expansion function will lead to generate multiple images of a sub-pixel. To avoid perceiving different images of a sub-pixel synchronously by the pupil 50, adjacent images of a sub-pixel should be designed with a distance large enough. A tracking device 70 is needed to determine the real-time position of the pupil 50. The control apparatus 30 determines the effective beam perceived by the pupil 50 from each sub-pixel according to the real-time position of the pupil 50. The loaded message of a sub-pixel is the projection message of the target object along this effective beam.

In the FIG. 25, the lens 40c can be removed. When the waveguide-type relay device 60 is adopted, the transmission light of a point on the aperture-type beam control device 20 enters the waveguide-type relay device 60 as parallel light, or the emitting light of a sub-pixel enters the waveguide-type relay device 60 as parallel light in above discussed FIG. 22, FIG. 24, and FIG. 25. Actually, with the premise that at least two perspective view, or at least two composite perspective views, or at least one perspective view and one composite perspective view being guided into a same pupil 50, the position relation between different optical elements shown in FIG. 22, FIG. 24, and FIG. 25 can be changed, or new optical element can be introduced in, or even the transmission light of a point on the aperture-type beam control device 20 or the light emitting from a sub-pixel enters the waveguide-type relay device 60 as non-parallel light.

### Embodiment 2

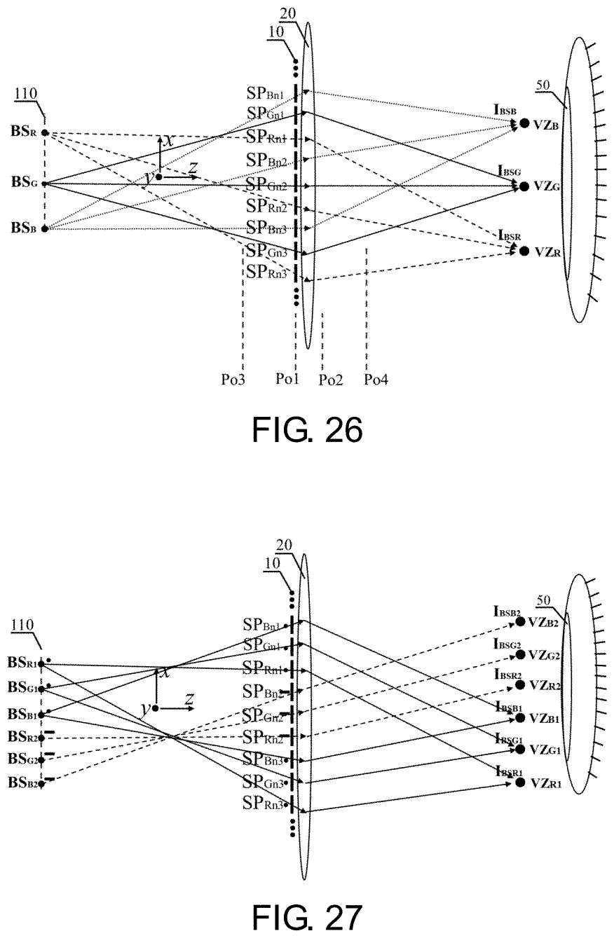

Adopt a passive panel as the display device 10. A backlight array 110 consisting of multiple backlights is needed to provide backlighting. An imaging device which projects the image of the backlight array 110 functions as the beam control device 20. This kind of beam control device 20 is named as imaging-type beam control device 20, as shown in FIG. 26. Take a display device 10 with K′=3 kinds of elementary-color sub-pixel as the display device 10. The x-direction aligned three sub-pixels of a pixel emit R (red), G (green), and B (blue) light, respectively. In FIG. 26, only a row of sub-pixels along the x direction are shown, with a subscript to mark the color of each sub-pixel's emitted light. For example, sub-pixel SP_{Bn1} emits blue light, denoted by B in the subscript. The K′=3 kinds of elementary-color sub-pixels are also K=K′=3 kinds of primary-color sub-pixels. The backlight array 110 consists of K′=3 backlights, i.e. backlights BS_{B}, BS_{G}, BS_{R}. Specifically, the backlight BS_{B} emits blue light, the backlight BS_{G} emits green light, and the backlight BS_{R} emits red light. Here, the sub-pixels that emit light of a same color are individually used as a sub-pixel group. That is to say, all the sub-pixels of the display device 10 are divided into a red sub-pixel group, a green sub-pixel group, and a blue sub-pixel group. An imaging-type beam control device 20 placed in the propagation path of the emitted lights from the backlight array 110, which is a lens in the FIG. 26, projects a real image of the backlight array 110. Correspondingly, the images of the K′=3 backlights are labeled as I_{BSB}, I_{BSG}, and I_{BSR} here. Each sub-pixel only modulates the incident light of a corresponding color, and the K′=3 backlights correspond to the K′=3 sub-pixel groups, respectively. That is to say, BS_{B} is the backlight corresponding to the blue sub-pixel group, BS_{G} is the backlight corresponding to the green sub-pixel group, and BS_{R} is the backlight corresponding to the red sub-pixel group. Wherein, the light projected by each backlight will pass through the non-corresponding sub-pixel group as noise when the display device 10 is not perfect. This noise is negligible in general case. So, it is considered that primary-color light from a backlight does not transmit the non-corresponding primary-color sub-pixels. According to the object-image relationship, at the image of a backlight, only the optical message projected by the sub-pixel group corresponding to this backlight is visible. This also means that the light distribution area of each backlight's image is the viewing zone of the sub-pixel group corresponding to this backlight. According to the display principle shown by the FIG. 2, when the distance between adjacent viewing zones is sufficiently small, at least two perspective views or/and composite perspective views will be perceived by a same pupil 50 for implementing the one-eye-multiple-view display. Here, the viewing zone for a sub-pixel group is the image of the corresponding backlight. Along a certain direction, the effective size of a viewing zone refers to the light distribution range in the area of said image where the light intensity value is greater than 50% of the peak value. The position relation between the display device 10 and the imaging-type beam control device 20 shown in the figure is not mandatory. For example, the display device 10 can also be placed at the position Po2, Po3 or Po4 when light from each backlight can cover the display device 10.

In order to accurately present the colors, perceiving at least K′ perspective views of different elementary colors by a same pupil 50 is preferred. In this case, the presence of only K′ viewing zones results in a limited observing space for the pupil 50. More viewing zones can be presented for a larger observing space when a backlight array 110 with orthogonal characteristics is designed. The orthogonal characteristics can be two polarization states with orthogonal linear polarization directions. As shown in FIG. 27, a backlight array 110 contains M=2 groups of backlights, and each backlight group contains K′=3 backlights of K′=3 kinds of elementary colors. And the M=2 groups of backlights emit linearly polarized “−” light and “⋅” light, respectively. The symbols “−” and “⋅” denote two mutually perpendicular linear polarization directions. Specifically, the backlights BS_{B1}, BS_{G1}, and BS_{R1} project blue, green, and red “⋅” light, respectively. And the backlights BS_{B2}, BS_{G2}, and BS_{R2} project blue, green, and red “−” light, respectively. Correspondingly, all sub-pixels which emit light of a same color are spatially divided into M=2 sub-pixel groups, with one group only receiving and modulating “⋅” light and the other group only receiving and modulating “−” light. Such sub-pixel groups are named as spatial-characteristics sub-pixel group. As shown in the figure, sub-pixels SP_{Bn1}, SP_{Bn3}, . . . constitute a blue sub-pixel group 1, sub-pixels SP_{Bn2}, . . . constitute a blue sub-pixel group 2; sub-pixels SP_{Gn1}, SP_{Gn3}, . . . constitute a green sub-pixel group 1, sub-pixel SP_{Gn2}, . . . constitute a green sub-pixel group 2; and so on. In order to make the sub-pixels of each spatial-characteristics sub-pixel group be arranged throughout the display device 10, an interlacing arrangement of sub-pixels among different spatial-characteristics sub-pixel groups which emit a same color light is preferred. As shown in the FIG. 27, the adjacent M=2 sub-pixels of a same color belong to different spatial-characteristics sub-pixel groups. Thus, there exist one-to-one correspondences between K′×M=3×2=6 spatial-characteristics sub-pixel groups and the 6 backlights. The image of each backlight functions as the viewing zone of the corresponding sub-pixel group. The two polarization states with orthogonal linear polarization directions shown in the FIG. 27 can also be replaced by the left-handed circular polarization and the right-handed circular polarization.

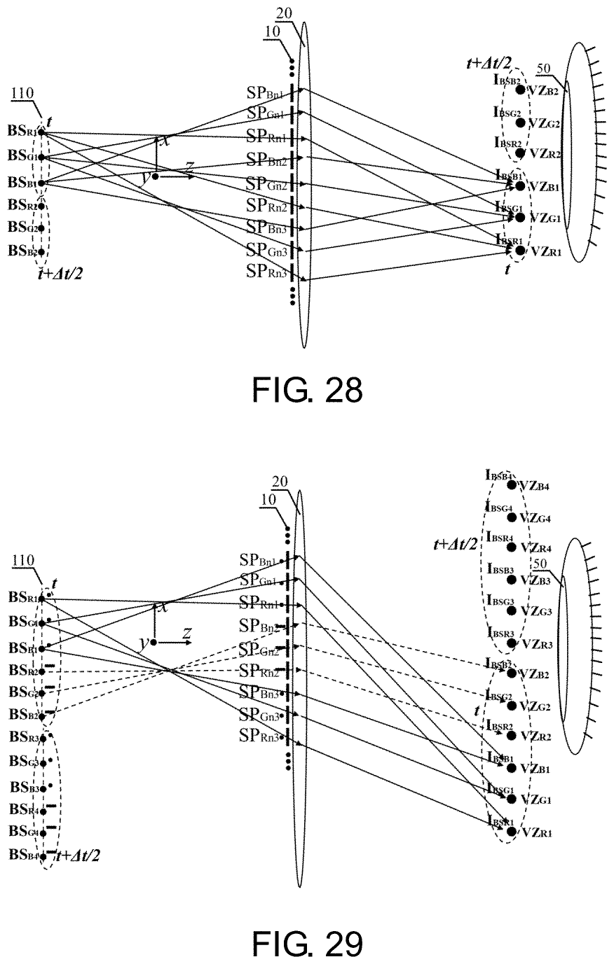

The orthogonal characteristics also can be temporal orthogonal characteristics that emitting light at different time-points sequentially. As shown in the FIG. 28, the backlight array 110 contains M=2 backlight groups. Each backlight group contains K′=3 backlights emitting light of different elementary colors. The M=2 backlight groups projects backlight at different time-points t and t+Δt/2 of a time period t˜t+Δt, respectively, by the control of the control apparatus 30. Specifically, the backlight group composed of the backlights BS_{B1}, BS_{G1}, and BS_{R1} projects backlight at the time-point t of a time period t˜t+Δt, and does not project light at the time-point t+Δt/2; the backlight group composed of the backlights BS_{B2}, BS_{G2}, and BS_{R2} projects the backlight at the time-point t+Δt/2, and does not project light at the time-point t. FIG. 28 shows the situation at timepoint t. Correspondingly, the sub-pixels that emit light of a same color are divided into two temporal-characteristics sub-pixel groups. The two temporal-characteristics sub-pixel groups are constructed by identical sub-pixel arrangement, but project perspective views to different viewing zones at different time-points of a time period. For example, at time-point t of a time period t˜t+Δt, the temporal-characteristics blue sub-pixel group 1 consisting of SP_{Bn1}, SP_{Bn2}, SP_{Bn3}, . . . projects a perspective view with VZ_{B1} as the corresponding viewing zone; at time-point t+Δt/2 of a time period t˜t+Δt, the temporal-characteristics blue sub-pixel group 2 consisting of the same SP_{Bn1}, SP_{Bn2}, SP_{Bn3}, . . . projects a perspective view with VZ_{B2} as the corresponding viewing zone. Similarly, other sub-pixel groups project corresponding perspective views. Based on temporal-characteristics, perspective views corresponding to K′×M=6 viewing zones get presented for one-eye-multiple-view display. A larger M needs a display device 10 with higher frame rate, to avoid obvious flicker. The viewing zones shown in the FIGS. 27 and 28 can interchange their spatial positions.

Furthermore, the orthogonal characteristics also can be hybrid characteristics, for example, the combination of temporal characteristics and polarization orthogonality (such as two polarization states with orthogonal linear polarization directions). As shown in FIG. 29, within a time period of t˜t+Δt, the backlights BS_{R1}, BS_{G1}, and BS_{B1} which emit “⋅” light are turned on at time-point t, but are turned off at time-point t+Δt/2. The backlights BS_{R2}, BS_{G2}, and BS_{B2} which emit “−” light are turned on at time-point t, but are turned off at time-point t+Δt/2. The backlights BS_{R3}, BS_{G3}, and BS_{B3} which emit “⋅” light are turned on at time-point t+Δt/2, but turned off at time-point t. The backlights BS_{R4}, BS_{G4}, and BS_{B4} which emit “−” light are turned on at time-point t+Δt/2, but turned off at time-point t. Correspondingly, the sub-pixels emitting light of a same color are spatially divided into two spatial-characteristics sub-pixel groups. Then, each spatial-characteristics sub-pixel group projects different perspective views corresponding to their respective viewing zones at different time-points of a time period, functioning as two hybrid-characteristics sub-pixel groups. Then, within a time period t˜t+Δt, the four mutually independent hybrid-characteristics sub-pixel groups which emit light of a same color can project four perspective views to the corresponding four viewing zones, respectively. Specifically, the blue hybrid-characteristics sub-pixel group consisting of SP_{Bn1}, SP_{Bn3}, . . . projects a perspective view corresponding to VZ_{B1} through VZ_{B1} at time t, and projects a perspective view corresponding to VZ_{B3} through VZ_{B3} at time t+Δt/2. The blue hybrid-characteristics sub-pixel group consisting of SP_{Bn2}, . . . projects a perspective view corresponding to VZ_{B2} through VZ_{B2} at time t, and projects a perspective view corresponding to VZ_{B3} through VZ_{B3} at time t+Δt/2. Totally, 12 viewing zones get presented. Repeat this process during other time periods. Based on the persistence of vision, the projected 12 perspective views, passing through the 12 viewing zones, can increase the display depth by designing smaller intervals between adjacent viewing zones or provide a larger observing space.

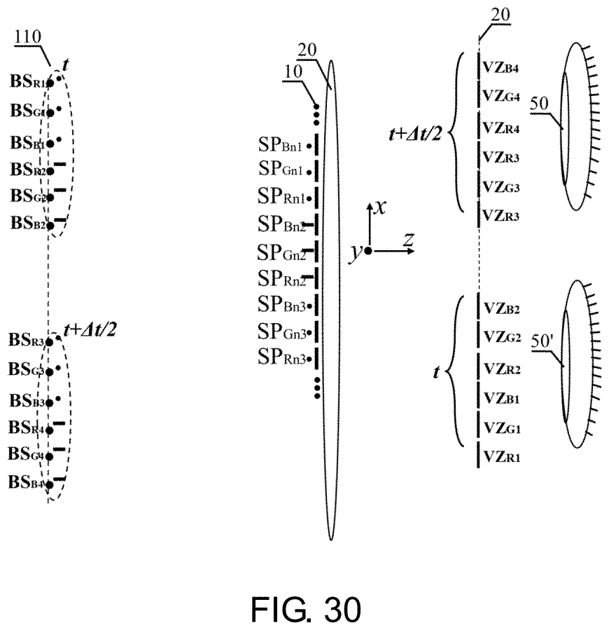

The number of view zones presented in FIGS. 27 to 29 increases when more orthogonal characteristics are employed. When the number of generated viewing zones is sufficient, the viewing zones can be spatially divided into two groups. These two viewing-zone groups correspond for the left pupil 50′ and right pupil 50 of a viewer, respectively, as shown by the FIG. 30. Under this condition, the method described above can be directly applied to the two eyes of a viewer. Correspondingly, the spatial positions of the backlights should be designed for the two eyes accordingly. Furthermore, when the number of viewing-zone groups can respond for eyes of two or more viewers, multiple-viewer display can be performed.

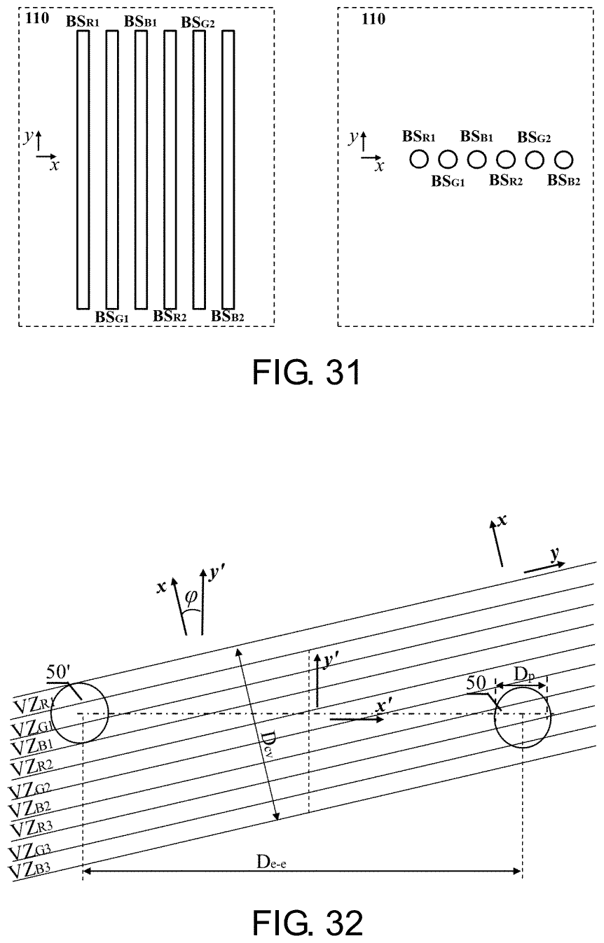

In above figures, each backlight can take a long strip shape, which can only be arranged along one-dimensional direction. Along the arrangement direction, the effective size of a corresponding viewing zone should be smaller than the viewer pupil diameter Dₚ. Along other direction, it can be greater than Dₚ. Each backlight also can take a spot shape, with the effective size of a corresponding viewing zone being smaller than Dₚ along any direction, which can be arranged along one-dimensional direction or at a two-dimensional surface. These two kinds of backlights are named as stripy backlights and spotty backlights, respectively. When a spotty backlight is used, the viewing zones shown in above figures can be extended to be arranged at a two-dimensional surface. FIG. 31 shows an example of the stripy and spotty backlights.

When the stripy backlights are used, another design is useful for effectively covering both pupils of a viewer by the viewing zones. As shown in FIG. 32, a smaller value of the intersection angle φ between the alignment direction x of the viewing zones and the direction y′ being perpendicular to the line connecting the two eyes can increase the coverage range of the viewing zones along the x′ direction. The x′ direction is along the line connecting the two eyes. FIG. 32 shows the case where the pupil 50 and the pupil 50′ are just covered by the least necessary number of viewing zones. Different sub-pixel groups of the display device 10 project different perspective views to the corresponding viewing zones VZ_{R1}, VZ_{G1}, VZ_{B1}, . . . , respectively. D_{cv} denotes the coverage size of viewing zones along the x direction. The coverage size D_{cv}ctg (φ) of the viewing zones along the x′ direction increases with decreasing of the φ, which means a larger observing space for the viewer. The interval between adjacent viewing zones should keep being smaller than the diameter Dₚ of the pupils. Due to the introduction of an inclination angle φ, the viewing zones can cover the viewer's two pupils even when D_{cv}<Dₑ₋ₑ. Dₑ₋ₑ is the binocular distance of the viewer. Furthermore, when the viewer's pupils are not on the plane of the viewing zones, a smaller φ will increase the range that the eyes can perceive the projected images. What needs to be noticed lies in that the perceived image can be a composite perspective view under this condition. The minimum value of φ is also limited by an extreme value, preventing the beams which pass through a same viewing zone from entering different pupils simultaneously.

In above figures, adjacent sub-pixels are shown being separated. Actually, the K′ elementary-color sub-pixels of each pixel can also be spatially superposed, such as a display device 10 with K′ kinds of color backlights being projected onto a common sub-pixel sequentially by the color wheel. Under this condition, in the display process, more time points are needed. For example, the time segment t˜t+Δt/2, should be further divided into K′ sub-time-periods for sequential incident of the K′ color backlights.

When displaying a primary-color object, designing K′=3 perspective views with different primary colors for a same pupil 50 will result in that only one perspective view of the object's primary-color is actually presented to the eye. That is to say, the one-eye-multiple-view display fails to execute under this condition. To solve this problem, the primary-color object can be replaced by an object with original color+χ(White)=original color+χ(R+G+B), where χ<1. For example, to display a green spatial point, the color message of the point is replaced by 0.2*W (R+G+B)+G, which requires the superposition of three primary-color beams instead of only one green beam.

The display device 10 takes K′=K=3 as an example in the above part. The values of K′ and K can be different. For example, a display panel with four kinds of sub-pixels of R, G, B and W (white) can also be employed as the display device 10 with K′=4 and K=3. Correspondingly, at least one backlight group consisting of K′ backlights of different elementary-colors is needed to construct the backlight array 110. Light from the white sub-pixels can pass through the filters corresponding to the other K=3 kinds of primary colors as noise. To avoid this kind of noise, the backlight corresponding to the non-primary-color sub-pixel group should be endowed with an orthogonal characteristic being different to other backlights corresponding to the primary-color sub-pixel groups. For example, the white sub-pixel group projects beams at a time-point different to other primary-color sub-pixel groups, accompanied by the synchronous turning-on or turning-off of the corresponding backlights. Or, the beams from white backlight and other primary-color backlight are designed to be with left-handed circular polarization and right-handed circular polarization, respectively. Simultaneously, sub-pixel groups correspond to the white backlight only can receive and modulate light with left-handed circular polarization, sub-pixel groups corresponding the K=3 primary-color sub-pixel groups only can receive and modulate light with left-handed circular polarization.

In addition, the method disclosed in the present patent application does not restrict the specific shape of the sub-pixels of the display device 10. For example, the sub-pixel of the display device can take a rectangular shape, or a square shape. The arrangement mode of the sub-pixels in a pixel can be the RGB arrangement mode shown in above figures, or other arrangement modes, such as the PenTile arrangement. In addition, in the above figures, the display device 10 is exemplified by the transmissive display device. The display device 10 can be a reflective display device. The spatial positions of the backlights are not limited to a plane, and they also can be arranged at different depths, i.e. spatially.

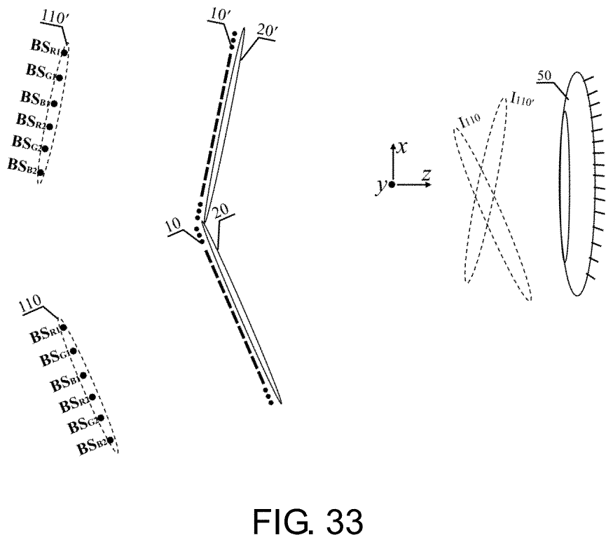

Each of above structures also can be used as a basic structure, and two or more such basic structures can be combined to construct a composite structure to increase the field of view. As shown in FIG. 33, taking two basic structures as an example, the backlight array 110, the display device 10, and the imaging-type beam control device 20 together form a basic structure, and the backlight array 110′, the display device 10′, and the imaging-type beam control device 20′ together form another basic structure. The viewing zones generated by the two basic structures both are designed to be in front of the pupil 50, and their display devices are arranged seamlessly linked up for a larger field of view.

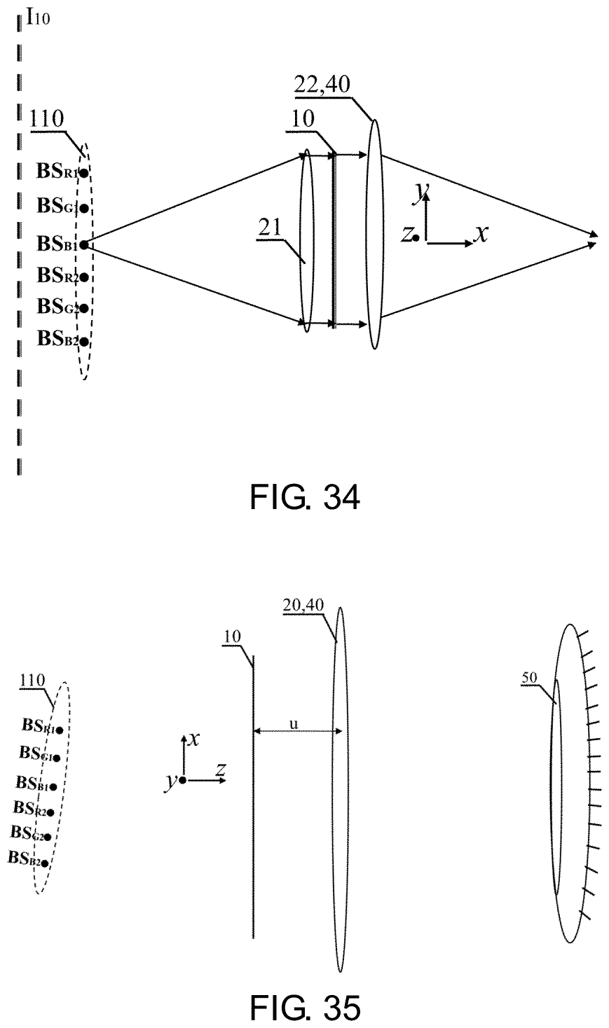

In the above structures shown in FIGS. 26 to 30 and the basic structures shown in FIG. 33, a projection device 40 can be introduced to project the image of the display device 10. Since the imaging-type beam control device 20 and the projection device 40 both have imaging functions, there exist mutual influences between them, and they can share the common component or components. As shown in the FIG. 34, the components 21 and 22 constitute an imaging-type beam control device 20, and the component 22 is also the projection device 40. I₁₀ is the enlarged virtual image of the display device 10 on the projection device 40. In FIG. 34, the components 21 and 22 of the imaging-type beam control device 20 both take lenses as an example. The backlights of the backlight array 110 are placed on the focal plane of the component 21. Actually, the distance between the backlights and the component 21 can be not equal to the focal length of the component 21, and the backlights can be placed at different depths. The component 22 and the component 21 also can be other optical devices for imaging the backlight resources and the display device 10. In FIG. 35, the imaging-type beam control device 20 and the projection device 40 are integrated in to a lens device.

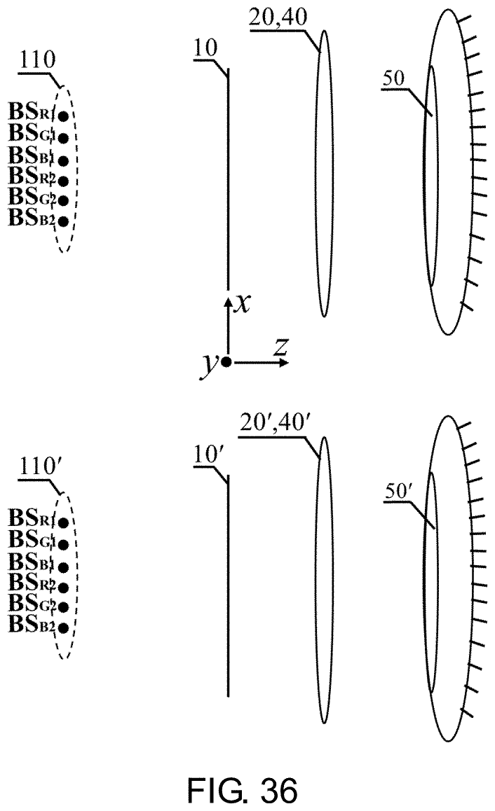

In FIGS. 34 and 35, the image I₁₀ of the display device 10 functions as an equivalent display device which may replace the above-mentioned display device 10 and may proceed one-eye-multiple-view display based on the same method and process. The structure with the projection device 40 is often used as an eyepiece for a near-eye display optical engine, and two such eyepieces build up a binocular display optical structure, as shown in FIG. 36.

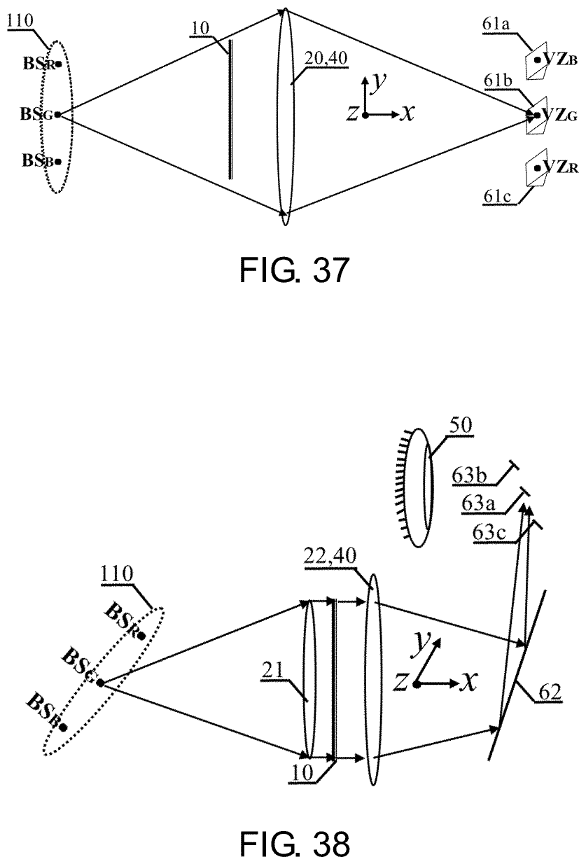

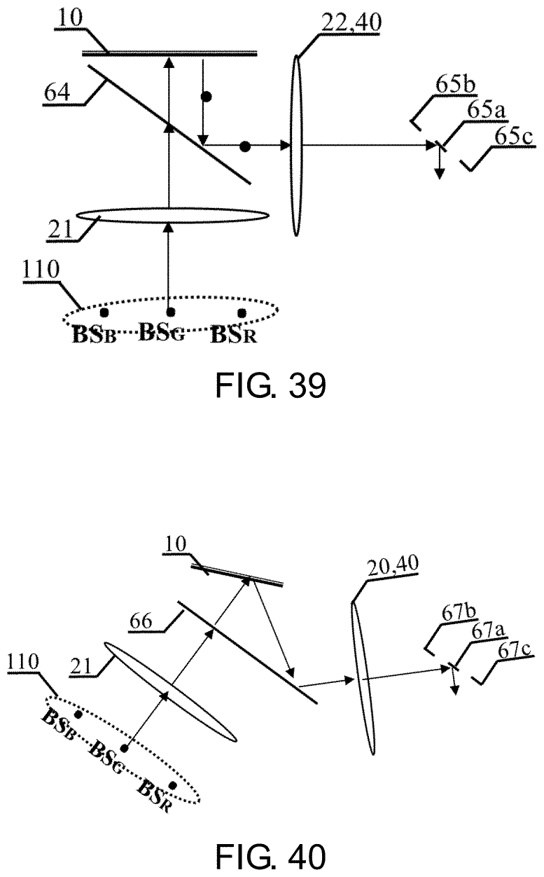

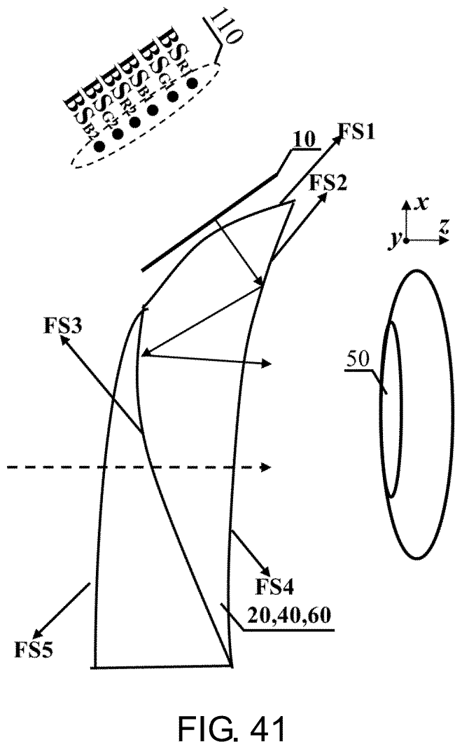

In the structures shown in FIGS. 34 and 35, a relay device 60 also can be introduced in to guide beams to the zone where the pupil 50 located, such as the semi-transparent and semi-reflective surface shown in the FIG. 6. Other optical devices or optics modules can also be used as the relay device 60. For example, the relay device 60 in FIG. 37 is constructed by the mirrors 61a, 61b, and 61c placed in each viewing zone; the relay device 60 in FIG. 38 is constructed by the the mirrors 62, 63a, 63b, and 63c. The semi-transparent and semi-reflective surface 64, the reflective surface 65a, the reflective surfaces 65b, 65c in FIG. 39 also construct a relay device 60. The angular-characteristic surface 66, the reflective surfaces 67a, 67b, 67c in the FIG. 40 also construct a relay device 60. The relay device 60 shown in FIG. 37, FIG. 38, FIG. 39 or FIG. 40 may be introduced in the structures shown in FIGS. 34 and 35. The shown display device 10 in the FIG. 40 is a reflective display device. The angular-characteristic surface 66 has a transmission property for light from a backlight which enters at a small incident angle, and has a reflection property for a light that from the display device 10 which enters at a large incident angle. FIG. 41 shows an optical structure of a free-surface relay device. The free-surface relay device consists of a transmission surface FS1, a reflection surface FS2, a semi-transparent and semi-reflective surface FS3, a transmission surface FS4, and a transmission surface FS5. Among them, the transmission surface FS1, reflection surface FS2, semi-transparent and semi-reflective surface FS3, and transmission surface FS4 perform the functions of the imaging-type beam control device 20 and the projection device 40. The reflection surface FS2 and semi-transparent and semi-reflective surface FS3 perform the function of a relay device 60. FS5 works as a compensation device, counteracting the influence of FS3 and FS4 on the incident ambient light. In the figure, a lens also can be placed between the backlight array 110 and the display device 10 as a component of the imaging-type control device 20 to focus the light from each backlight. In FIG. 34 to FIG. 41, the backlight array 110 is only shown by a small number of backlight groups for simplicity.

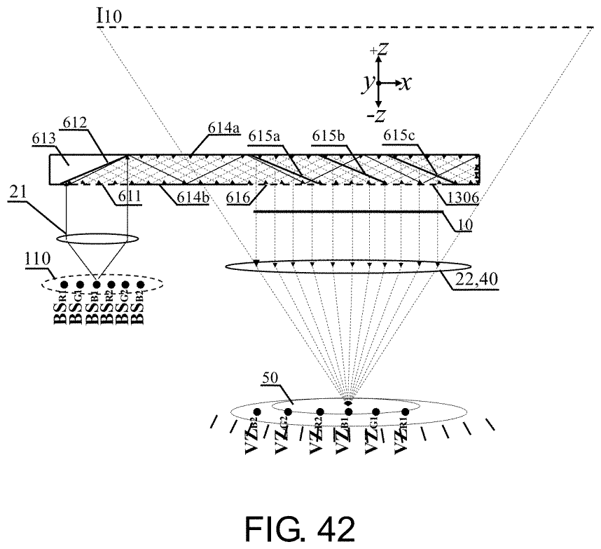

The relay device 60 also can be an optical waveguide device, which is named as a waveguide-type relay device 60. A waveguide-type relay device 60 often consists of the entrance pupil 611, the coupling-in element 612, the waveguide 613 with two reflection surfaces 614a and 614b, coupling-out element 615 and exit pupil 616. In the structure shown in FIG. 42, the waveguide-type relay device 60 is placed between the backlight array 110 and the display device 10, to guide light from each backlight to the display device 10 with their respective characteristics. Light from each backlight of the backlight array 110, such as the backlight BS_{B1}, is converted into parallel light by the component 21 of the imaging-type beam control device 20. Then, by the coupling-in element device 612, the reflective surfaces 614a and 614b, and the coupling-out element 615, light from the backlight BS_{B1} converges to its image. The light distribution zone of this image is the viewing zone of the corresponding sub-pixel group. The component 22 of the imaging-type beam control device 20 also paly the function of projecting the image I₁₀ of the display device 10 as the projection device 40. During this process, the waveguide-type relay device 60 also participates in the imaging of the backlights and the imaging of the display device 10. The coupling-out element 615, which is constructed by the partial-reflective surfaces 615a, 615b, and 615c, have the pupil extending function. The incident light of the partial-partial reflective surface 615a is partially guided to the exit pupil, with the other part keeping propagating in the waveguide 613 to incident on adjacent partial-reflective surface 615b once again. Then, repeat this process to furtherly enlarge the exit pupil, making the outgoing light from each backlight cover the display device 10. Then, with the image I10 as an equivalent display device, one-eye-multiple-view can get implemented according to the above-mentioned principle and menthol. The component 40b also can be integrated into the coupling-out element 615.

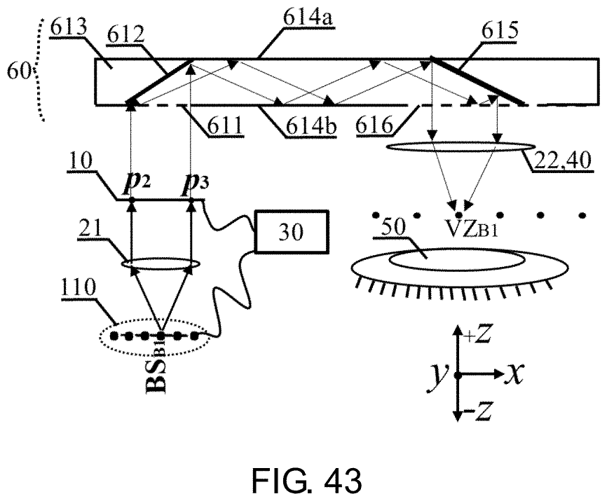

The waveguide-type relay device 60 also can be placed in front of the display device 10 in the propagation path of the light. As shown in FIG. 43, the light emitted by each backlight is modulated into a parallel light by the component 21 of the beam control device 20 before entering the display device 10. Then, guided by the waveguide-type relay device 60, beams from the display device 10 enter the component 22, which is not only a component of the beam control device 20, but also works as the projection device 40. The waveguide-type relay device 60 also participates in the imaging of the backlights and the imaging of the display device 10. The positions of the component 21 and the display device 10 also can be interchanged.

In above-mentioned figures, when the backlight takes a spotty or stripy shape, the light emitted by each point on a backlight can be converted into parallel light, as shown by the FIGS. 42 and 43. Actually, the position relation between different optical elements can be changed. And new optical elements also can be introduced in to make the exit light of a point of the backlight incident on the relay device 60 at a non-parallel state, including the situation of light from a sub-pixel incidenting on the relay device 60 at a parallel state.

The core idea of the present invention is to realize one-eye-multiple-view display through spatial superposition of the beams projected by the sub-pixels. At a spatial point to be displayed, more than one passing-through beams from sub-pixels of different colors superimpose into a spatial color light spot. Compared with existing one-eye-multiple-view display methods using pixels as the basic display unit, the method disclosed in this patent can increase the number of viewing zones by (K′−1) times, effectively improving the feasibility of implementation of the one-eye-multiple-view technology.

Above are only preferred embodiments of the present invention, but the design concept of the present invention is not limited to these, and any non-substantial modifications made to the present invention using this concept also fall within the protection scope of the present invention. Accordingly, all related embodiments fall within the protection scope of the present invention.

What is claimed is:

1. A three-dimensional display method based on spatial superposition of sub-pixels' emitted beams, wherein the method comprises the following steps:
(i) taking sub-pixels of a display device as basic display units, all sub-pixels emitting beams of a same color are taken as a sub-pixel group or divided into several sub-pixel groups;
wherein, all sub-pixels of the display device belong to K′ kinds of elementary colors respectively, including sub-pixels of K kinds of primary colors, where K′≥K≥2;
wherein, there exist K kinds of filters corresponding to sub-pixels of the K kinds of primary colors by a one-to-one manner, which have characteristics that a ratio between transmittance of the beams emitted by each kind of primary-color sub-pixels with respect to the corresponding filter and that of the beams emitted by each kind of primary-color sub-pixels with respect to any other (K−1) kinds of non-corresponding filters is large than 9;
and, the color of the beams emitted by a kind of elementary-color sub-pixels is defined as an elementary color, and a total of K′ kinds of elementary colors exist; the color of the beams emitted by a kind of primary-color sub-pixels is defined as a primary color and a total of K kinds of primary colors exist;
(ii) using a beam control device to guide the beam from each sub-pixel to the viewing zone corresponding to the sub-pixel group which contains the sub-pixel respectively, and to constrain the divergence angle of the beam from each sub-pixel;
wherein the constrained divergence angle of each beam is designed for a required light distribution on the plane containing the pupil of the viewer, and the required light distribution satisfies that a light distribution area with a light intensity value greater than 50% of a peak light intensity is smaller than a diameter of the pupil along at least one direction;
(iii) controlling each sub-pixel group to load and display a corresponding image by a control apparatus which is connected with the display device, wherein the image message loaded on each sub-pixel is a target object's projection message along the sub-pixel's emitted beam;
wherein, the image displayed by a sub-pixel group is a perspective view of the target object, and the image displayed by a composite sub-pixel group which is tiled by mutually complementary parts of different sub-pixel groups is a composite perspective view;
wherein, a spatial position distribution of the viewing zones corresponding to different sub-pixel groups are arranged to guarantee the same pupil of the viewer perceiving at least two perspective views, or at least two composite perspective views, or at least one perspective view and one composite perspective view.

2. The three-dimensional display method based on spatial superposition of sub-pixels' emitted beams according to claim 1, wherein the beam control device is an aperture array consisting of at least one aperture group;
wherein, each aperture group contains K apertures, with each aperture attached by one said filter and different apertures attached by different kinds of the filters;
wherein, for each aperture, a sub-pixel group consisting of sub-pixels corresponding to the aperture's filter takes the aperture as the viewing zone when the beams from the sub-pixel-group pass through the aperture.

3. The three-dimensional display method based on spatial superposition of sub-pixels' emitted beams according to claim 2, wherein the aperture array contains M aperture groups, and different aperture groups only allow light with different orthogonal characteristics passing through, respectively, where M≥2.

4. The three-dimensional display method based on spatial superposition of sub-pixels' emitted beams according to claim 3, wherein the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and two polarization states of left-handed circular polarization and right-handed circular polarization.

5. The three-dimensional display method based on spatial superposition of sub-pixels' emitted beams according to claim 1, wherein the beam control device is an aperture array consisting of at least one aperture group,
wherein, each aperture group contains K′ apertures, with the K′ apertures of the aperture group corresponding to K′ kinds of elementary colors in a one-to-one manner;
wherein, the aperture corresponding to a primary color is attached by the filter corresponding to the primary color;
and for each aperture, a sub-pixel group emitting light with an elementary color corresponding to the aperture takes the aperture as the corresponding viewing zone when the beams from the sub-pixel group passing through the aperture;
wherein, the K apertures of an aperture group attached by filters allow beams with an identical orthogonal characteristic passing through, while other (K′−K) apertures of the aperture group respectively allow light of other (K′−K) kinds of corresponding orthogonal characteristics passing through, with all these (K′−K+1) kinds of orthogonal characteristics being mutually different.

6. The three-dimensional display method based on spatial superposition of sub-pixels' emitted beams according to claim 5, wherein the aperture array contains M aperture groups, and different aperture groups only allow light with mutually different orthogonal characteristics passing through, respectively, where M≥2.

7. The three-dimensional display method based on spatial superposition of sub-pixels' emitted beams according to claim 5, wherein the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and the two polarization states of left-handed circular polarization and right-handed circular polarization.

8. The three-dimensional display method based on spatial superposition of sub-pixels' emitted beams according to claim 1, wherein
the display device is a passive display device equipped with a backlight array consisting of at least one backlight group, and the beam control device is an optical device which projects a real image of the backlight array;
wherein, each backlight group consists of K backlights which emit light of K different kinds of primary colors, respectively,
and the light distribution area of the real image of the backlight array is taken as the viewing zone of the sub-pixel group which emit light of the color same to the backlight and whose emitted beams pass through the light distribution area.

9. The three-dimensional display method based on spatial superposition of sub-pixels' emitted beams according to claim 8, wherein the backlight array contains M backlight groups, and different backlight groups emit light with mutually different orthogonal characteristics, where M≥2.

10. The three-dimensional display method based on spatial superposition of sub-pixels' emitted beams according to claim 9, wherein the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and the two polarization states of left-handed circular polarization and right-handed circular polarization.

11. The three-dimensional display method based on spatial superposition of sub-pixels' emitted beams according to claim 1, wherein
the display device is a passive display device equipped with a backlight array consisting of at least one backlight group, and the beam control device is an optical device which projects a real image of the backlight array;
wherein, each backlight group consists of K′ backlights which emit light of K′ kinds of elementary colors, respectively,
and the light distribution area of the real image of the backlight array is taken as the viewing zone of a sub-pixel group which emits light of a color same to the backlight and whose emitted beams pass through the light distribution area;
wherein, the K backlights of a backlight group which emit light of K kinds of primary colors have an identical orthogonal characteristics, while other (K′−K) backlights of the backlight group emit light of other (K′−K) kinds of orthogonal characteristics, respectively, with all the (K′−K+1) kinds of orthogonal characteristics being mutually different.

12. The three-dimensional display method based on spatial superposition of sub-pixels' emitted beams according to claim 11, wherein the backlight array contains M backlight groups, and different backlight groups emit light of mutually different orthogonal characteristics, respectively, where M≥2.

13. The three-dimensional display method based on spatial superposition of sub-pixels' emitted beams according to claim 11, wherein the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and the two polarization states of left-handed circular polarization and right-handed circular polarization.

14. The three-dimensional display method based on spatial superposition of sub-pixels' emitted beams according to claim 1, wherein the step (ii) further comprises placing a projection device at a position corresponding to the display device to form an enlarged image of the display device.

15. The three-dimensional display method based on spatial superposition of sub-pixels' emitted beams according to claim 1, wherein the step (ii) further comprises inserting a relay device into the optical path to guide the beams from the display device to the area around the pupil or pupils of the viewer.

16. The three-dimensional display method based on spatial superposition of sub-pixels' emitted beams according to claim 15, wherein the relay device is a reflective surface, or a semi-transparent semi-reflective surface, or a free-surface relay device, or an optical waveguide device.

17. The three-dimensional display method based on spatial superposition of sub-pixels' emitted beams according to claim 1, wherein the step (iii) further comprises real-timely determining a position of the viewer's pupil by a tracking device connecting with the control apparatus.

18. The three-dimensional display method based on spatial superposition of sub-pixels' emitted beams according to claim 17, wherein
the step (iii) further comprises determining the sub-pixels whose emitted beams enter the pupil according to the real-time position of the pupil, and setting message loaded on each of the sub-pixels to be the target object's projection message along one beam of its emitted light which enters into the pupil.

19. The three-dimensional display method based on spatial superposition of sub-pixels' emitted beams according to claim 17, wherein,
the step (iii) further comprises determining the sub-pixel groups whose emitted beams enter the pupil according to the real-time position of the pupil, and taking the sub-pixel groups as effective sub-pixel groups.

20. The three-dimensional display method based on spatial superposition of sub-pixels' emitted beams according to claim 6, wherein the different orthogonal characteristics refer to temporal orthogonal characteristics permitting an incident light passing through at different time-points sequentially, or two polarization states with orthogonal linear polarization directions, or two polarization states of left-handed circular polarization and right-handed circular polarization, or combinations of the temporal orthogonal characteristics and the two polarization states with orthogonal linear polarization directions, or combinations of the temporal orthogonal characteristics and the two polarization states of left-handed circular polarization and right-handed circular polarization.
